(19) United States
(12) Patent Application Publication
(10) Pub. No.: US 2026/0080106 A1
(43) Pub. Date: Mar. 19, 2026

(54) SECURE INTERMEDIARY DEVICE

(71) Applicants: Scott McGowan, Federal Way, WA (US); Matthew Allard, Edmonds, WA (US)

(72) Inventors: Scott McGowan, Federal Way, WA (US); Matthew Allard, Edmonds, WA (US)

(21) Appl. No.: 19/332,644

(22) Filed: Sep. 18, 2025

Related U.S. Application Data
(60) Provisional application No. 63/695,916, filed on Sep. 18, 2024.
(60) Provisional application No. 63/695,928, filed on Sep. 18, 2024.

(51) Int. Cl. G06F 21/72; G06F 13/40

(52) U.S. Cl. CPC G06F 21/72; G06F 13/4068

(57) ABSTRACT

A secure intermediary device is disclosed. The secure intermediary device provides a secure communication channel between an input device such as a keyboard or mouse and a computing device. The secure intermediary device may be integrated into the input device or external to the input device. The secure intermediary device may communicate with the computing device using a secure application implemented using the computing device, such as an internet browser extension. The secure intermediary device may include at least some components of a retro device. Techniques for building a platform that enables partners to develop or integrate applications with the secure intermediary device are also disclosed.

### TECHNICAL FIELD

The present disclosure relates to a secure intermediary device that enables user input to be securely provided to a multitasking computing device.

### BACKGROUND

Modern computing devices such as smartphones, laptops, or desktop computers are typically complex devices that implement a variety of software applications. The complexity of modern computing devices, and their broad functionality, produces security vulnerabilities.

### BRIEF SUMMARY

A secure intermediary device is disclosed. The secure intermediary device provides a secure communication channel between an input device such as a keyboard or mouse and a computing device. The secure intermediary device may be integrated into the input device or external to the input device. The secure intermediary device may communicate with the computing device using a secure application implemented using the computing device, such as an internet browser extension. The secure intermediary device may include at least some components of a retro device, reducing waste. Techniques for building a platform based on the secure intermediary device are also disclosed.

### BRIEF DESCRIPTION OF THE SEVERAL VIEWS OF THE DRAWINGS

Embodiments are described with reference to the following drawings. In the drawings, like reference numerals refer to like parts throughout the various figures unless otherwise specified.

For a better understanding, reference will be made to the following Detailed Description, which is to be read in association with the accompanying drawings:

FIG. 1 illustrates a secure intermediary device implemented in a keyboard having modular functionality in some embodiments.

FIG. 2 illustrates trustkey functionality of a secure intermediary device in some embodiments.

FIGS. 3A and 3B illustrate an internal smartphone bus connector for interfacing with a secure intermediary device in some embodiments.

FIG. 4 illustrates peer-to-peer communication between secure intermediary devices in some embodiments.

FIG. 5 illustrates a secure intermediary device implementing a portable local firewall in some embodiments.

FIG. 6 illustrates end-to-end security implemented using a secure intermediary device in some embodiments.

FIG. 7A illustrates aspects of converting a multitasking computing device to implement a secure intermediary device in some embodiments.

FIG. 7B illustrates interactions between a multitasking computing device and a secure intermediary device in some embodiments.

FIG. 8 illustrates aspects of cartridges of a secure intermediary device in some embodiments.

FIG. 9 illustrates input encryption using a secure intermediary device in some embodiments.

FIG. 10 illustrates modular features of a secure intermediary device in some embodiments.

FIG. 11 illustrates modular features of a secure intermediary device in some embodiments.

FIG. 12 illustrates a secure intermediary device that includes modular telephone features in some embodiments.

FIG. 13 is a system diagram illustrating an example computing system for implementing embodiments described herein.

FIG. 14 illustrates a secure intermediary device with a cartridge implementing content streaming functionality in some embodiments.

FIG. 15 illustrates a secure intermediary device communicating with a multitasking computing device in some embodiments.

FIG. 16A illustrates input/output functionality of a secure intermediary device in some embodiments.

FIG. 16B illustrates a secure integrator device having input/output functionality communicating with multitasking computing device in some embodiments.

FIG. 17A illustrates a secure intermediary device having hub functionality in some embodiments.

FIG. 17B illustrates a secure intermediary device having hub functionality communicating with a multitasking computing device in some embodiments.

FIG. 18 illustrates a secure intermediary device having cartridges with serial or parallel functionality in some embodiments.

FIG. 19 illustrates a local zone and a remote zone of a computing environment including a secure intermediary device in some embodiments.

FIG. 20 illustrates example manufacturing processes for the secure intermediary device in some embodiments.

FIG. 21 illustrates various attributes of the secure intermediary device in some embodiments.

FIG. 22 illustrates features of a secure intermediary device implemented using a retrofitting kit in some embodiments.

### DETAILED DESCRIPTION

Conventional computing systems are typically non-secure. Despite manufacturers'claims regarding the implementation of secure applications on conventional computing systems, such applications are implemented using non-secure common operating systems. Operating systems used by general-purpose computing devices are often complex, and are designed to expose significant functionality and information to applications executed using the operating systems.

The complexity and scope of general-purpose (i.e., “multitasking”) operating systems makes them vulnerable to zero-day exploits, software flaws, compromised third-party applications, poorly-configured security settings, etc. Accordingly, even applications thought to be secure are subject to operating system vulnerabilities. These vulnerabilities may be used to obtain sensitive data such as user inputs received by the operating system, files stored on a computing device implementing the operating system, values stored in random access memory of the computing device, etc.

Computing devices implementing non-secure operating systems often handle critical information such as passwords, private cryptocurrency wallet keys, permission tokens, etc. Exposure of this data may result in loss of control over critical computing resources, financial assets, accounts, or other resources. Accordingly, improved secure input devices are much needed in the current digital transactional world. The critical income and savings of entities being used for buying goods, trading in precious metals and commodities, debt notes, and cryptocurrencies all require enhanced security.

Present widely-distributed desktop and portable computing systems are multitasking-oriented to be integrated with both for-profit and free open-source operating systems and implement a wide variety of applications (i.e., they are “multi-tasking computing devices”). Only the most extremely specialized and well-trained experts can ensure that input provided to these computing systems via input devices such as keyboards, audio-I/O, video-I/O, files, and text strings are not exposed by the operating system or intercepted by nefarious parties. Even with the most expensive and well-maintained popular computer systems that include multiple costly add-on security software and multiple positive user identification methods used in series via multiple network and hardware devices offer only limited protection.

Even when a user has a high rate of positive identification methods engaged, and there is criteria being used for modestly improved user identification of the intended user versus a pretender on typical networks and popular computer equipment and operating systems, when the user conducts sensitive transactions on servers or peer-to-peer as well as private communications with other intended persons, some or all the data of these transactions can still be intercepted locally or via network pathways or via malware riding along as one of many multi-tasks processed on the other peer or the server.

In response to the disadvantages of traditional computing device operating systems, techniques disclosed herein enable data to be securely provided using a secure intermediary device.

In various embodiments, the secure intermediary device provides a secure communication channel for providing user input or other data from a user input device to a computing device. Accordingly, even if the computing device or another computing device between the secure intermediary device and the computing device is compromised, communications between the secure intermediary device and the second computing device are not exposed.

In various embodiments, the secure intermediary device is a super-local user-I/O firewall integrated into a user input device, a computing device that resides not just locally as firewall software in a personal computer workstation, or a rack-mounted computing device that is a firewall for a single or multiple computer workstations against network or Internet security-privacy threats. In some embodiments, the secure intermediary device is implemented using a single tasking software-model as much as is possible for improved self-security that is physically interposed between a group of devices that are comprised of a workstation and the same workstation's user I/O devices. In some embodiments, the secure intermediary device is implemented using one or more special-purpose computing devices configured to provide little or no excess functionality, so as to reduce vulnerabilities of the secure intermediary device.

In various embodiments, the secure intermediary device includes a set of focused single-tasking appliances that bring fully secure privacy with complete end to end encryption for communications and transactions to desktop computing systems and portable devices. In some embodiments, the appliances include one or more of a user input device such as keyboard or pointer, or audio and video interfaces. In some embodiments, the appliances include digital connectivity, analog connectivity or any combination thereof.

In various embodiments, the secure intermediary device includes or communicates with audio and video peripherals such as displays, speakers, etc. In some embodiments, the secure intermediary device includes one or more single-tasking or single-task-oriented cartridges that have their own I/O, memory, processors, and code used to perform a task. In some embodiments, the secure intermediary device expands an existing pool of desktop and portable computing systems that can achieve full user peer-to-peer or peer-to-server secure connections even through non-secure operating systems or other network infrastructures. In some embodiments, the secure intermediary device acts as a final layer before encrypting or decrypting data to or from a user.

In some embodiments, the secure intermediary device includes its own dedicated HID keyboard and pointing HID device. In some embodiments, the secure intermediary device includes one or more removably attachable cartridges that have yet more digital or analog I/O types via a single tasking methodology, dramatically improving privacy and security when connected to multitasking computing devices such as popular desktop and portable computers and smartphones. In some embodiments, the secure intermediary device enables common users to achieve full security and privacy with additional indicators of visual and audio notifications to inform the user if they have a secure connection or not. In some embodiments, audio-visual warnings of the secure intermediary device indicate if there are external parties or automated systems attempting to intercept private data. This implementation also provides a low cost and easy method for user's secure data to be intentionally shared with designated receivers when desired for their own needs.

Local computers and distant remote servers or friends peer computers, when receiving encrypted I/O from these now secure and private, now encrypted HID devices and other peripheral I/O devices such as text, email, audio, video data and files, has the ability to decrypt the stream, via a corresponding secure intermediary device, or add-on software to software applications such as internet browsers, writing programs, data base programs or at the operating system level, such as to decrypt at a virtualized operating system (OS)

As with other popular operating systems and devices, in various embodiments, the secure intermediary device and its cartridges provide a platform for many other suppliers of Internet and local computing applications of a more secure nature to gravitate to a single-tasking cartridge methodology residing with the keyboard device (normally considered as a peripheral I/O appliance). In some embodiments, suppliers of single-tasking cartridges are approved by the secure intermediary device developers as to help guarantee the absence of nefarious parties gaining access to the users most trusted passwords, files, and data. In some embodiments, the secure intermediary device is configured to operate with un-licensed cartridges but with required audio visual notifications to the local user that security may not be guaranteed.

A peer-to-peer scenario can permit users to utilize the final security layer of the secure intermediary device or not. For example, a user may specify that the secure intermediary device is to communicate with peer devices with which it can perform end-to-end encryption. However, in some embodiments, greater security is ensured if all the users in a peer-to-peer scenario all use the secure intermediary device. The secure intermediary device can act as a stand-alone system with the functionality previously noted even without a computing system attached such as when a user may be traveling with less capabilities than larger computers and smartphones provide.

A strategic use case for such a secure intermediary device are the millions of retired systems such as 8-bit computers that typically were cartridge based gaming and home computing devices with built in keyboards, and basic video and sound output, which could be re-purposed into fully secure systems via a cartridge that contains ROM for the device to access. Whereas the old methodology provided only a keyboard input, game-port, and pointer device input, a new cartridge also provides a modern compatible hardware port connection to standard workstations, servers, tablets, and smartphones having non-secure operating systems, but offer multi-tasking, where users and system managers may install additional new applications.

The secure intermediary device can be implemented with additional physical keys as typically used by popular modern non-secure operating systems. The old baseband video output could be fed into attached low cost devices that can input baseband analog video to provide the user with a local display that assists with more diverse and secure usage.

Bringing back retro devices, such as old 8-bit and 16 bit retro computing devices has a practical benefit of being made of higher quality plastics than are often now used, avoids the old systems ending up in garbage landfills, and cuts down the need for a new plastic being made from fossil fuel products with the associated pollution. Old plastic cases tend to be stronger and more rugged overall and no longer emit plastic out-gassing. Professionals or qualified enthusiasts can change out old components such as keyboards and circuit boards that helps recycle those metallic parts, including some gold plating, to proper facilities. As used herein, the term “retro” typically refers to an out-of-production device.

The re-purposed desktop and portable retro systems can act in daily use as typical input/output platforms with the added benefit of operating in-a secure manner. For some users, there would be no need for additional equipment to manage regular secure and non-secure usage.

In some embodiments, a standalone base unit Human input Device (HID) secure intermediary device (to include optional connections to more peripheral I/O devices such as memory sticks, audio and video devices) includes an HID keyboard or HID pointing device. In some embodiments, the secure intermediary device includes one or more cartridge slots. In some embodiments, the secure intermediary device could be, if so desired by its owner, used as a standard keyboard in a fully insecure manner, similar to how almost all personal computer, tablet, and smartphone input devices operate.

In some embodiments, the secure intermediary device also has ability to drive video into a small optional low cost COTS display mounted on the keyboard that assists the users in ease of use and management of macro keys such as user names and passwords, or even long repeated strings as may be needed in document writing. The fully secure privacy improves cumbersome user log-in (local and remote) procedures such as multi-level authentications from any location (via different or separated devices or networks), as such processes can be automated-or become unnecessary.

The secure intermediary device has cartridge slots that accept cartridges that have memory, processing, and physical digital and analog I/O as to add additional secure functions with little to no risk that multi-tasking systems have.

When the secure intermediary device is acting as a keyboard and pointer to an attached computer or smartphone, user interactions cannot be intercepted by any nefarious code as can be found in popular computing systems. The user input is decoded locally in add-on application software or at a distant server or other peer user location.

In some embodiments, the cartridges are based on a USB port of a crypto-wallet device or a cartridge that can communicate to TV entertainment boxes for improved and easier use with simple remotes that lack keyboards and pointers.

In some embodiments, a cartridge is used for dedicated audio and video communication to other users or distant servers.

In various embodiments, cartridges and the base secure intermediary device unit are systematically designed as to avoid unintended and/or undesired usage, or at least users are audio-visual warned of communication, between the multiple use-case functions, such as cartridge-A of a secure video-phone function, to or from cartridge-B of a stock-market trading function and/or from the main keyboard of the secure intermediary device. This includes both unintended and/or undesired unencrypted communication between any multiple cartridges that may be plugged into the secure intermediary device or between the base secure intermediary device unit, the cartridges and any application or operating system, or malware in any local user computer, remote server, or peer.

In various embodiments, the secure intermediary device at least partially solves the issue that typical modern multi-tasking smartphones and personal computers have considerable communications between components of the opening systems, and many software applications that are not only difficult for the user to prevent, but that the user usually has little or no knowledge of these threatening communications that are highly deleterious to the user's security and privacy. The intent is to carry out security and privacy improvements with the maximum of ease of installation and sharing of the secure intermediary device with any modern PC or smartphone platform that the user may operate.

In some embodiments, a final security layer is provided where signals are not encrypted for user analog and digital I/O through the local fully secure privacy secure intermediary device, thus preventing popular computer platforms, tablets, smartphones, and networks and their operating systems as well as possible malware from intercepting either user names, passwords, data strings to interned applications or files by nefarious parties.

Additionally, such a modern secure intermediary device may be built-up, via a very low cost add-on or retrofitting kit, for owners of old 8-bit and 16 bit personal computers as to re-purpose these retired units by acquiring the needed additional keys and modern phy-communications I/O of typical modern personal computer platforms via an added cartridge. Pollution created by the manufacture of new additional computing systems is avoided by this novel re-use of retired systems. These retro systems that were previously used as holistic personal computers having a processor, memory, I/O of keyboard, display, printer-control, and with disk-storage ports they were capable of running almost any and all new software written for it, and so now become a closed peripheral appliance with largely fixed firmware as to make other late model computer systems and phones fully secure and private.

In various embodiments, the secure intermediary device intermediates communication between the user-I/O and a computing device such a computer workstation or smartphone, providing a final security-privacy protective layer for analog or digital I/O.

In some embodiments, the secure intermediary device includes a low-specification processor that may include functionality to interface with standard hardware ports for attaching to modern, popular, multi-tasking computers and smartphones, that generally have myriad security and privacy issues, mostly arising from excessive operating system scope, updates, or third-party software. Platform vulnerabilities of multi-tasking computers include: operating system sub-components that the user has little control over, numerous application programs, an numerous device driver software. Often, these vulnerabilities are compounded over hundreds or thousands of programs written or maintained by various entities.

In some embodiments, the secure intermediary device comprises a portable device connects to a computing device via an encrypted channel. In various examples, the secure intermediary device is battery-powered or draws power from the computing device. In one example, the secure intermediary device provides power to the computing device.

In some embodiments, the secure intermediary device includes I/O interfaces for connecting peripheral I/O devices such as memory sticks, audio and video devices, display devices, etc.

In some embodiments, the secure intermediary device includes one or more interfaces for receiving plug-in cartridges that implement additional functionality, such as performing processing functions of real-time audio or video encoding and decrypting.

In various embodiments, the secure intermediary device communicates with a secure platform including a hardware device or a software application such as an internet browser, internet browser plug-in, database, or a virtualized operating system (OS), a virtual machine. In various embodiments, end-to-end encrypted communication is established between the secure intermediary device and the secure platform.

In some embodiments, a cartridge of the secure intermediary device includes dedicated memory and processor configured to implement functionality of the cartridge. In some embodiments, the cartridge utilizes a multi-tasking computing device such as a smartphone logic board that is modified to implement a single-task oriented operating system. In some embodiments, the cartridge performs a single task, such as interacting with a specified third-party application or application programming interface. In some embodiments the cartridges are for the enhancement of fully secure privacy conditions. However, modern computing and Internet systems often interface with complex physical ports (“PHYs”) and drivers for popular connectivity such as USB, Ethernet, Bluetooth and Wi-Fi. These functions may require some driver code that can be considered a multi-task as it may share the same processor core, stack, or both, of the computing hardware in the cartridge. Accordingly, in various embodiments, the cartridge implements various functionality, such as functionality used to interface with peripherals or other input, storage, or computing devices.

In some embodiments, a cartridge enables solid state memory sticks to act as virtual drives for file transport and storage, or a port for a crypto-wallet, or even set top box infrared I/O control.

In various embodiments, a cartridge provides improved security or security visibility. In some embodiments, the cartridge includes one or more indicator lights or transducers that indicates an operational status of the cartridge, such as indicating when data is being communicated to or from the cartridge, or where add-on devices are communicating data to and from components such as a memory stick or microphone, whether communications are in a secure mode or not, or a level of security such as if the secure intermediary device is communicating with a similar secure intermediary device at a remote end point, or a lesser secure, lesser-private device, such as a less-optioned secure intermediary device where some of the audio or video functions are still being tasked in another users local personal computer or phone, or entirely at the remote location in just a personal computer or phone.

In various embodiments, the secure intermediary device is incorporated into, or is in communication with, a retro or vintage device or components thereof, such as input devices or peripherals including a keyboard, trackpad, mouse, etc. In one example, a keyboard of a retro device is functional despite other hardware of the retro device being outdated or non-functional. The keyboard is used to communicate with the secure intermediary device, which encrypts inputs provided via the keyboard and securely communicates the inputs to another computing device.

This enables components of the retro device to be brought back into daily use, avoiding electronic waste and pollution associated with the manufacture of new hardware. In some embodiments, components of a retro device such as an old 8 and 16 bit PC with embedded keyboard are combined with sub-assemblies including one or more of: an additional user input component, a pointing device port, a read-write non-volatile memory stick port, or modern I/O, to incorporate at least some components of the retro device into a secure intermediary device that communicates with conventional multitasking devices such as current, popular, multi-tasking platforms of PC's or smartphones via an added cartridge bus-adaptor. In some embodiments, a cartridge-bus-adapter for the retro systems includes a read-only memory (“ROM”) to boot-up the old hardware to implement at least some functionality of the retro device. In some embodiments, the cartridge bus-adaptor includes one or more memories, one or more processors, and hardware I/O that permits modern keyboard functionality.

In some embodiments, the secure intermediary device employs a multitasking computing device such as a smartphone as a display device, or to perform other limited functions. In some embodiments, an operating system of the multitasking computing device is erased and limited-functionality software is installed to enable the multitasking computing device to function as a local display for the secure intermediary device or a re-purposed retro system that can benefit from a keyboard mounted local display, such as for improved macro key and password management. In some embodiments, circuits of the multitasking computing device that may threaten security or privacy are disabled via software, by physically altering the circuits, or by installing additional control switches or warning indicators. In some embodiments, the local display communicates directly with the secure intermediary device. In some embodiments, the local display communicates with the secure intermediary device via a cartridge, so as to be on the secure side of the final layer analog and digital I/O to the local user.

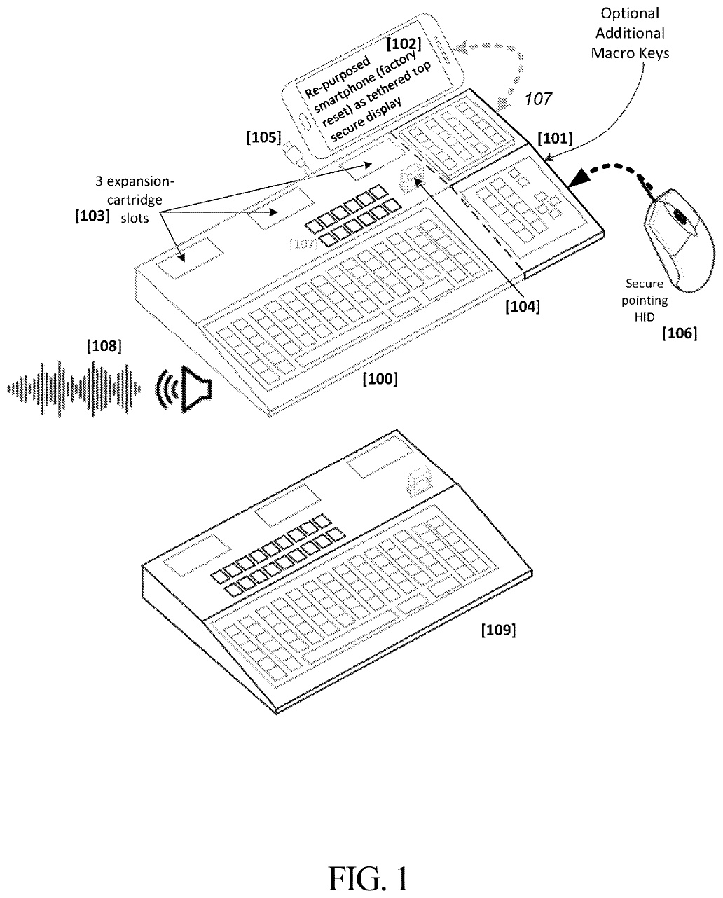

FIG. 1 illustrates a secure intermediary device implemented in a keyboard having modular functionality in some embodiments. Base secure keyboard 109 illustrates a secure keyboard without modular hardware, such as expansion module 101 or storage device 104 installed in some embodiments.

Secure keyboard 100 implements a custom single task oriented user-keyboard-pointer firmware with communication pathway 105 to send user input to a multitasking computing device such as a desktop personal computer workstation, or any computing device. In some embodiments, secure keyboard 100 communicates with secure local display 102 using communication pathway 107.

In some embodiments, secure local display 102 is implemented using a multitasking computing device, such as a re-purposed low-cost popular COTS smartphone. In some embodiments, secure local display 102 is based on a multitasking computing device loaded with display software and having a small, limited operating system. In one example, secure local display 102 is a multitasking computing device modified not to include non-secure applications. In some embodiments, secure local display 102 includes hardware, software, or both, focused on interaction with secure keyboard and pointing device 106. In some embodiments, expansion module 101, which includes one or more physical user input components such as a button, slider, touchscreen, etc., communicates with secure keyboard 100 to provide additional user input functionality.

In some embodiments, secure keyboard 100 includes a cartridge and additional hardware for Ethernet, Wi-Fi, and Bluetooth connections as to make secure keyboard 100 capable of communicating with multitasking computing devices without necessarily being connected to a multitasking computing device such as a desktop workstation, laptop, tablet, or smartphone. In some embodiments, a smartphone is used as a secure display 102 display and to provide a wireless network connection. In some such embodiments, the smartphone includes safety measures such as added safety displays or controls to prevent inadvertent network connections when not desired for security reasons. In some embodiments, the smartphone is a feature-reduced smartphone that is physically modified or modified through software or firmware to reduce a feature set of the smartphone. In some embodiments, the smartphone implements a single-task-focused operating system that enables the smartphone to perform functions used to implement features of the secure intermediary device, and disables the smartphone from performing functions not used to implement features of the secure intermediary device.

In some embodiments, expansions module 101 is associated with user identifying information that protects against use of secure keyboard 100 by unauthorized users. In some embodiments, expansion module 101 includes user authentication information such as passwords or tokens, macro-keys, or other. In some embodiments, a first set of features of expansion module 101, such as macros, is accessible by a first set of users. In some embodiments, a second set of features of expansion module 101, such as authentication information, is accessible by a second set of users. In some embodiments, user authentication information, macros, or other data, is stored using storage device 104. In one example, storage device 104 is a smaller pocket-sized removable storage device such as a USB device, that stores user-specific authentication information, macros, etc.

In some embodiments, storage device 104 includes data such as passwords stored in nonvolatile memory. In some embodiments, storage device 104 is in an easy-to-carry form factor such as a memory stick.

In various embodiments, encryption of input data produced using secure keyboard 100 or pointing device 106, audio and video connections, etc. connect to multitasking computing devices or other secure intermediary devices. In some embodiments, symmetric or asymmetric encryption methods are used. In some embodiments, user inputs produced using secure keyboard 100 or pointing device 106 are provided toward a computing device in fully encrypted mode, whether for local applications on a computing device in direct communication with secure keyboard 100. In some embodiments, for distant remote peers, or servers or devices, encryption remains on the entire transport path to the remote devices. In some embodiments, a computing device receiving encrypted data from secure keyboard 100 implements an application that decrypts the user input of secure keyboard 100 inside of the application or at remote systems or virtualized operating systems, making interception of the user input more difficult. In some embodiments, the application is a modular add-on that can be easily added to popular applications such as internet browsers, email, word processors, etc. In one example, the application is a browser add-on that enables end-to-end encrypted communication between secure keyboard 100 and an internet browser. In some embodiments, the user input includes a user-name or passwords. In some embodiments, the user input includes any user input for a user experience in a corresponding software or browser.

In some embodiments, transducer 108 provides warnings for the user to remain more secure and to avoid mistakes of accidentally communicating in non-secure and private modes. In various embodiments, transducer 108 includes on or more lights, speakers, etc.

In some embodiments, secure keyboard 100 use its own circuits or cartridges or connected multitasking computing device such as a multitasking computing device implementing secure display 102 to provide, Ethernet, Wi-Fi, Bluetooth, etc. to communicate with other computing device to which user input is to be provided, thus avoiding the need for an additional multitasking computing device to provide user input from secure keyboard 100 to other computing devices. This combination is portable and secure, with symmetric and asymmetric encryption, I/O for audio-video communication, texting, or other network transactions. Because final non-encrypted digital or analog input/output occurs in secure keyboard 100, pointing device 106, or in a cartridge installed in one or cartridge slots 103, a local password or other authentication information feature can be used to protect communications. In one example, a crypto-wallet is implemented using a cartridge that includes memory and a processor. In another example, a cartridge is used to add enhanced functionality of locally displayed high resolution video or audio I/O hardware with the final non-encrypted digital or analog input/output occurring at secure keyboard 100 or pointing device 106.

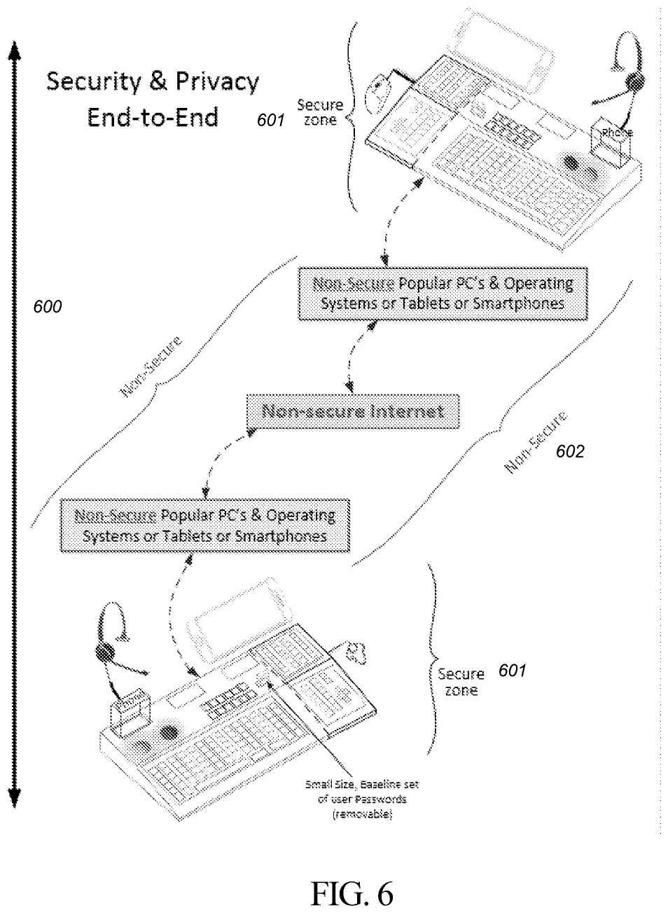

In some embodiments, secure keyboard 100 communicates with another secure intermediary device to provide complete end-to-end secure and private meetings between multitasking computing devices with little or no additional application software running on multitasking personal computers or servers other than COTS commercial communications programs and/or free open-source communications programs as to provide the connections set-ups along with network IP address connections whether through servers or peer-to-peer. Referring to FIG. 6, environment 600 may include some combination of secure zones 601, and non-secure zones 602. In some embodiments, a non-secure or semi-secure browser on their multitasking device and its remote server webpage code are configured to not show sensitive information such as a user-name or password on a connected multitasking device, but rather to show the sensitive information using secure display 102. In various embodiments, some or all user input information, input fields, graphical user interfaces, etc. for an application are displayed using secure display 102 rather than a multitasking computing device in communication with secure keyboard 100. In one example where the application is an email application, secure display 102 is used to display an interface for writing an email. The email is provided to a multitasking computing device in encrypted text, and appears in plain text on secure display 102.

In some embodiments, a secure intermediary device includes hardware, software, firmware, or any combination thereof that enables authentication information for a user of the secure intermediary device to be stored at a separate computing device such as a server, a trusted affiliate remote network location, etc. In some embodiments, once the secure intermediary device authenticates to the separate computing device. In some embodiments, a combination of local and remote authentication is used.

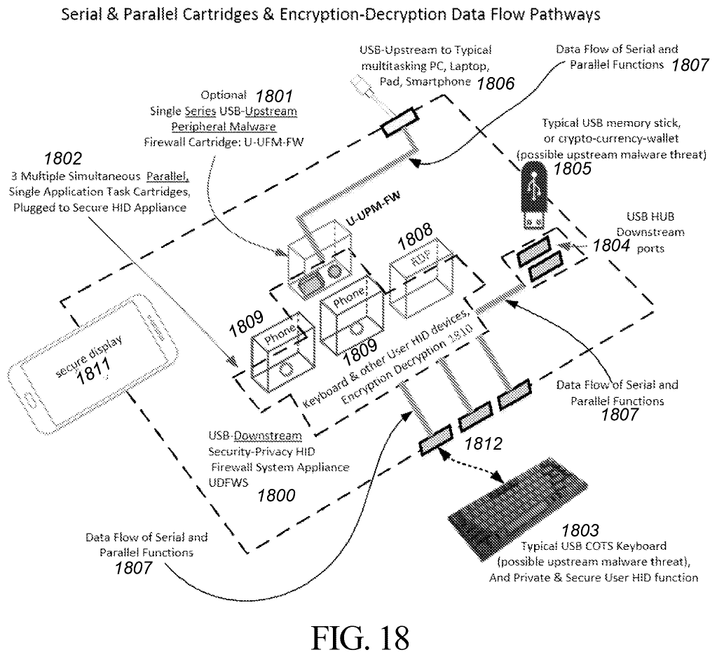

FIG. 18 illustrates a secure intermediary device 1800 having cartridges with serial or parallel functionality in some embodiments. In various embodiments, one or more cartridges enable functionality of secure intermediary device 1800 to be expanded. As shown in FIG. 18, secure intermediary device 1800 comprises a USB peripheral device that intermediates communication between input device 1803 and a multitasking user device.

Secure intermediary device 1800 includes firewall cartridge 1801, which encrypts or decrypts communications between input device 1803 and a multitasking computing device. In some embodiments, firewall cartridge 1801 implements a firewall between secure intermediary device 1800 and a multitasking computing device. In some embodiments, I/O 1806 enables communication between secure intermediary device 1800 and a multitasking computing device. In some embodiments, I/O 1806 is configured to enable communication with designated applications running on the multi-tasking computing device, such as a local PC intended application's, laptop, server, tablet, local virtual machine, smartphone or remote server.

In various embodiments, secure intermediary device 1800 includes any number of cartridge I/Os to support cartridges with various functionality. In some embodiments, the cartridges operate in parallel, in series, or any combination thereof. In one example of series operation, a first cartridge implements a telephone feature, and a second cartridge in series with the first cartridge implements a digital-to-analog conversion (DAC) feature to produce an analog signal based on a digital signal received from the first cartridge.

In another example, parallel cartridges 1802, including phone cartridges 1809, implement a secure, encrypted phone function of one or multiple calls wired in parallel via analog or digital appliance cross cartridge 1809. In some embodiments, parallel cartridges 1802 enable simultaneous connections, optionally mixed as to enable conference calls with local USB or Bluetooth peripherals, and network or Internet data movements via the multiple cartridges. In some embodiments, parallel cartridges 1802 enable text or files to be provided in parallel to a phone call. In some embodiments, a cartridge implements functions for television, an HDMI-secure-picture-in-picture display etc. In some embodiments, cartridge 1808 implements a remote desktop protocol (“RDP”). In some embodiments, cartridge 1808 includes in-series wired function cartridge slot for adding a cartridge in series, such as firewall cartridge 1801.

In some embodiments, secure intermediary device 1800 is used for financial transactions and securities trading utilizing a cartridge that acts as a cryptocurrency wallet.

In some embodiments, secure intermediary device 1800 enables data pipeline 1807 to communicate with one or more of I/O ports 1804, allowing peripheral connected devices such as storage device 1805 to communicate with a multitasking computing device via I/O 1806. In some embodiments, applications from the downstream external USB or Bluetooth connected user's peripheral devices via I/O ports 1804, and/or parallel cartridges 1802 functions through one or more in-series cartridges such as firewall cartridge 1801. In some embodiments, data sourced from connected peripherals such as input device 1803 or storage device 1805 or other HID peripherals such as digital headsets, mouse, camera, or another user smartphone, via downstream ports 1812 are scanned for known data patterns of malware using firewall cartridge 1801.

In some embodiments, based on detecting a potentially malicious data pattern, communication with a multitasking computer via I/O 1806 is limited or ceased, and an auditory or visual warning is produced, such as using secure display 1811, to prevent malicious data from being communicated to the multitasking computing device. In some embodiments, firewall cartridge 1801 prevents malicious data from moving from the multitasking computing device toward user peripherals devices such as input device 1803.

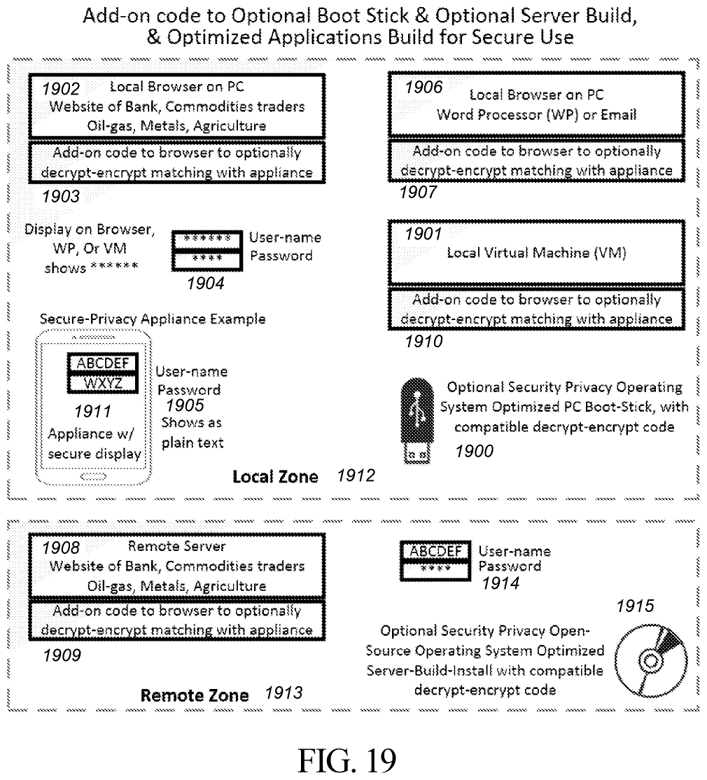

FIG. 19 illustrates a local zone and a remote zone of a computing environment including a secure intermediary device in some embodiments.

In various embodiments, secure intermediary device 1911 communicates with a designated application running on a multitasking computing device. In some embodiments, secure intermediary device 1911 operates in a multi-secure intermediary device mode via a communication network, whereby secure intermediary device 1911 securely communicates with one or more other secure intermediary devices. In some embodiments, first data such as actual data of voice, sound, and text are encrypted by the secure intermediary devices. In some embodiments, second data such as control portions that the upstream typical USB host device needs for its USB stack management of input devices is not encrypted.

In some embodiments where secure intermediary device 1911 communicates with a multitasking computing device such as server 1908 using add-on code 1909. In some embodiments, secure intermediary device 1911 communicates text such as user-names and passwords 1914, voice sound, video, pointer device input, files, etc. using a USB connected single Security-Privacy USB peripheral appliance that includes add-on code 1903, 1907, 1910, or 1909. In some embodiments, an application on a local multitasking computing device in local zone 1912 or server 1908 in remote zone 1913 includes one or more databases, word processors, browsers, email applications, etc. In some embodiments, local browsers 1902 and 1906 include add-on code 1903 and 1907, respectively, for special feature upgrades. In one example, the special feature upgrades include encryption and decryption.

In some embodiments, names and passwords 1904 that a user may not want to appear on a display of a multitasking computing device in local zone 1912, which may be displayed with applications of browser 1902, word processor, email, 1906 or virtual machine 1901, is at least partially obscured when displayed on the multitasking user device. In some embodiments, plain text user-names or passwords 1905 are displayed using a secure display of secure intermediary device 1911. Similarly, in some embodiments, plain text of an encrypted email is displayed using the secure display of intermediary computing device 1911.

In some embodiments, a secure boot device 1900 is used to implement encryption and decryption of communications of local zone 1912. In some embodiments, install disk 1915 is used to implement encryption and decryption of communications of remote zone 1913.

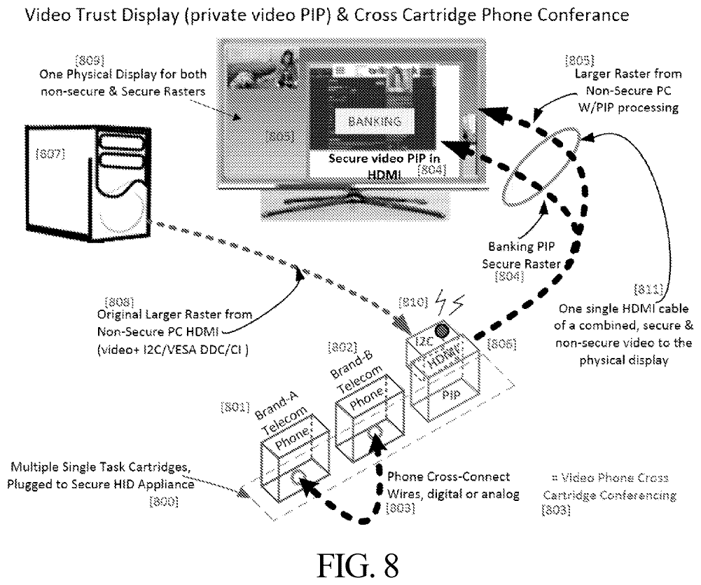

FIG. 8 illustrates aspects of cartridges of a secure intermediary device in some embodiments. In various embodiments, secure intermediary device includes multiple cartridge slots to provide for multiple secure single tasking functions while selectively communicating data locally from cartridge-to-cartridge via a hardware and/or software communication pathway 803 in secure intermediary device 800 without this data escaping the physical boundaries of the secure intermediary device 800, except as intended by the user.

In various embodiments, a video-in port for input of non-secure computer display data, such as non-secure display data 805 or signal 808, is received as input by secure intermediary device 800. Based on the display data, secure intermediary device 800 provides a picture-in-picture display to display 809 that includes a display data window and a secure display window.

In some embodiments, a signal from PIP-video cartridge 806 provides a signal of multitasking computing device 807 and to non-secure single or multiple displays 809. In some embodiments, PIP-video cartridge 806 adds its own secure video raster as a PIP (picture in picture) including a fully secure visual display of user's secure intermediary device display data, but with no loss of security or reverse HDMI data pathway back to the typical non-secure multitasking computing device 807. This enables secure data to be conveniently displayed on a same display as non-secure data from multitasking computing device 807. In some embodiments, private-secure PIP image contents 806 are displayed inside non-secure display data 805. By implementing display memory raster using PIP-video cartridge 806, display memory raster is denied to multitasking computing device 807. This may prevent nefarious monitoring of information displayed using display 809. In some embodiments, PIP-video cartridge 806 enables switching in and out of a PIP secure video mode to eliminate the need for an additional display to provide a secure viewing mode. This reduces the inherent risks associated with multitasking systems created by thousands of disparate suppliers of parts including video display components, and coding that includes video drivers, thus preventing private data would appear in the secure display from being accessed.

In one example, secure raster 804 corresponding to the PIP secure display zone is processed in raster memory of PIP-video cartridge 806, and the final video entering the physical display, is included in signal 811, from the PIP cartridge.

In various embodiments, the original non-secure video signal 808 from the multitasking computing device 807 includes IC2-Vesa standard DOC/Cl low speed serial data to physical display ID reading and physical display setup. In some embodiments, PIP-video cartridge 806 monitors I2C signals of signal 808 to detect excessive, untimely, or inappropriate I2C communication, that could, albeit rare in possibility, slowly attempt to send a copy of secure raster 804 back to the multitasking computing device 807. In some embodiments, a transducer 810, such as an LED, of PIP-video cartridge 806 produces a warning based on detecting unusual I2C communication. In some embodiments, based on detecting unusual I2C communication, a notification is provided in visual secure image zone 804 of the PIP output.

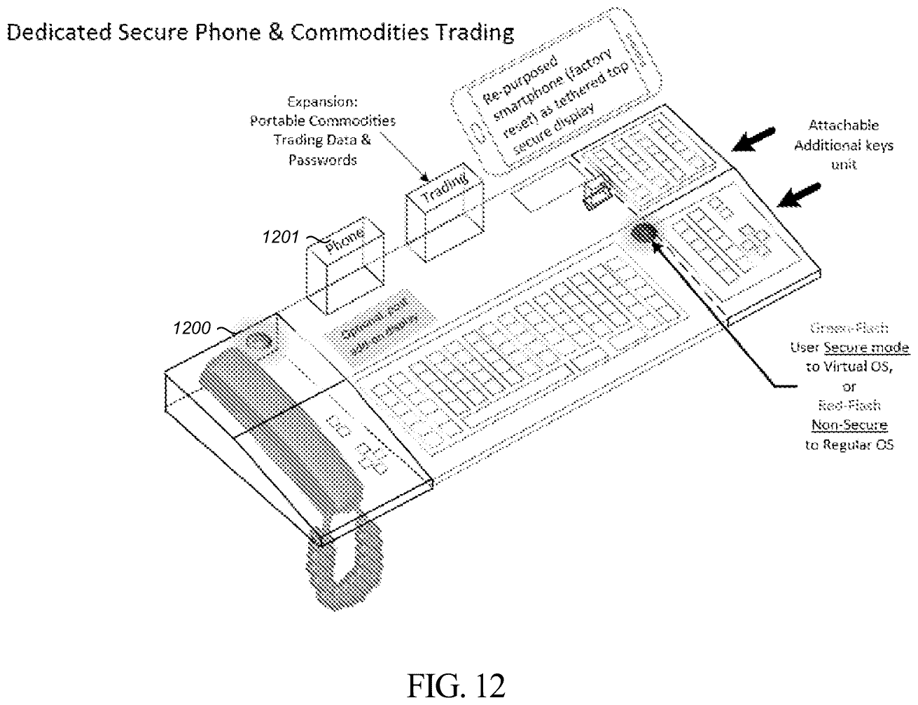

FIG. 12 illustrates a secure intermediary device that includes modular telephone features in some embodiments. In various embodiments, the secure intermediary device includes an add-on cartridge and hardware for a desktop and/or headset phone to make fully secure incoming and outgoing calls. In some embodiments, the secure intermediary device includes a physical phone handset 1200 and a phone-single-task-cartridge 1201 to implement the modular telephone functionality.

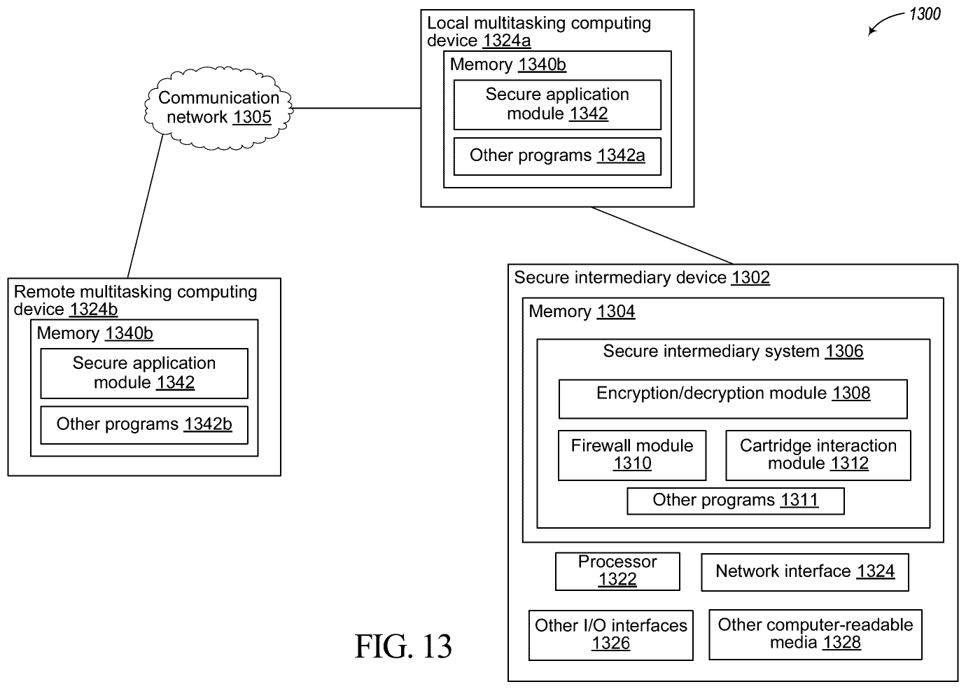

FIG. 13 shows a system diagram that describes one implementation of computing systems for implementing embodiments described herein. System 1300 includes secure intermediary device 1302, local multitasking computing device 624a, and remote multitasking computing device 624b, which may communicate using communication network 1305.

As described herein, secure intermediary device 1302 is a computing device that can perform functionality described herein for providing secure communications with a computing device. One or more special purpose computing systems may be used to implement secure intermediary device 1302, as described herein. Accordingly, various embodiments described herein may be implemented in software, hardware, firmware, or in some combination thereof. In the example shown in FIG. 13, secure intermediary device 1302 includes memory 1304, one or more processors 1322, network interface 1324, other input/output (I/O) interfaces 1326, and other computer-readable media 1328. In some embodiments, secure intermediary device 1302 is implemented at least partially using cloud computing resources.

Processor 1322 includes one or more processors, processing units, programmable logic, circuitry, or other computing components that are configured to perform embodiments described herein or to execute computer instructions to perform embodiments described herein. In some embodiments, processor 1322 include a single processor that operates individually to perform actions. In some embodiments, processor 1322 includes a plurality of processors that operate to collectively perform actions, such that one or more processors operate to perform some, but not all, of such actions. In some embodiments, processor 1322 is a single or few-task-oriented processor that performs a limited set of functions.

In various embodiments, memory 1304 includes one or more various types of non-volatile or volatile storage technologies. Examples of memory 1304 include, but are not limited to, flash memory, hard disk drives, optical drives, solid-state drives, various types of random-access memory (“RAM”), various types of read-only memory (“ROM”), other computer-readable storage media (also referred to as processor-readable storage media), other memory technologies, or any combination thereof. In some embodiments, memory 1304 stores information, including computer-readable instructions that are utilized by processor 1322 to perform actions, including at least some embodiments described herein.

In some embodiments, memory 1304 stores secure intermediary system 1306, which includes encryption/decryption module 1308, firewall module 1310, and cartridge interface module 1312.

In some embodiments, encryption/decryption module 1308 encrypts or decrypts data communicated between secure intermediary device 1302 and local multitasking computing device 1324a, remote multitasking computing device 1324b, or another computing device. In some embodiments, the data includes user input received via a user input device included in secure intermediary device 1302 or in communication with secure intermediary device 1302.

In some embodiments, firewall module 1310 provides a firewall that blocks potentially malicious data received from local multitasking computing device 1324a, remote multitasking computing device 1324b, or another computing device.

In some embodiments, cartridge interaction module 1312 manages interactions between processor 1322 or other components of secure intermediary device 1302 and a cartridge. In some embodiments, cartridge interaction module 1312 provides data from processor 1322 or memory 1304 to a cartridge, or obtains data from a cartridge.

In various embodiments, memory 1304 stores other programs 1311, which includes operating systems, user applications, or other computer programs. As discussed herein, in some embodiments, other programs 1311 are feature-reduced or tailored to core functionality of secure intermediary device 1302 (e.g., firewall functionality or encryption/decryption functionality) to reduce vulnerabilities.

In some embodiments, secure intermediary device 1302 includes network interfaces 1324, which are configured to communicate with other computing devices, such as local multitasking computing device 1324a, remote multitasking computing device 1324b, or another computing device. In some embodiments, network interfaces 1324 include transmitters and receivers (not illustrated) to send and receive data.

In various embodiments, other I/O interfaces 1326 includes interfaces for various other input or output devices, such as audio interfaces, other video interfaces, USB interfaces, physical buttons, keyboards, haptic interfaces, tactile interfaces, etc. In some embodiments, other computer-readable media 1328 includes other types of stationary or removable computer-readable media, such as removable flash drives, external hard drives, etc.

In various embodiments, local multitasking computing device 1324a is a laptop computer, smartphone, desktop computer, server, or other computing device. Local multitasking computing device 1324a includes memory 1340b, which includes secure application module 1342 and other programs 1342a. In some embodiments, secure application module 1342 implements an application used to securely communicate with secure intermediary device 1302. In some embodiments, local multitasking computing device 1324a includes components similar to those discussed with respect to secure intermediary device 1302.

In various embodiments, components of remote multitasking computing device 1324b are similar to like components described with respect to local multitasking computing device 1324a.

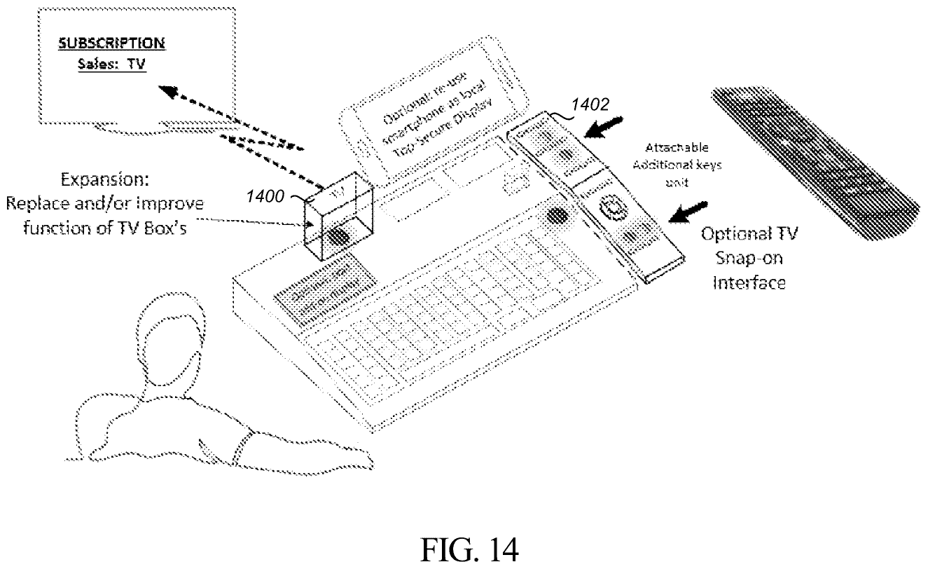

FIG. 14 illustrates a secure intermediary device with a cartridge implementing a content streaming functionality. In some embodiments, the secure intermediary device includes a cartridge 1400 or a connectable remote control device 1402 as the secure intermediary device can single task control a content streaming system and add its own channels with more in-depth and easier control compatibility of content streaming systems and channels being marketed worldwide, and allowing various persons sharing the device to retain considerably more than typical preferences and searches.

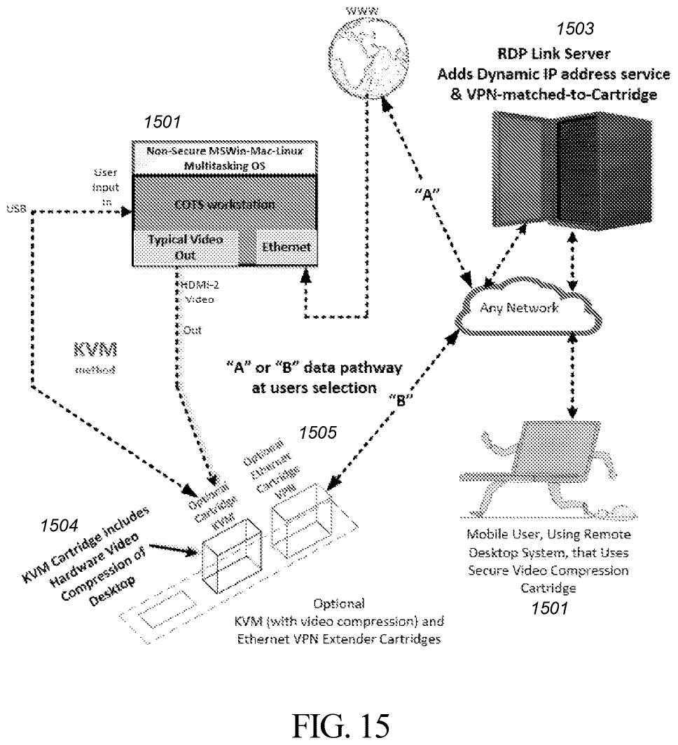

FIG. 15 illustrates a secure intermediary device communicating with a multitasking computing device 1500 in some embodiments. In some embodiments, the secure intermediary device controls aspects of multitasking computing device 1500 such as display I/O, audio I/O, user key or pointer inputs, etc. using kernel-based virtual machine (KVM) cartridge 1504. In some embodiments, virtualization cartridge 1504 performs hardware video compression of multitasking computing device 1500's desktop. In some embodiments, virtualization cartridge adds a Remote Desktop function in a peer-to-peer (e.g., to endpoint device 1501) or peer-to-server (e.g., server 1503) connection via any number of in between, non-secure equipment and software to an endpoint device such as a server, workstations, smartphone, etc.

In various embodiments, ethernet VPN cartridge 1505 works cooperatively with server 1503. In some embodiments, ethernet cartridge 1506 and multitasking computing device 1500 implement software video compression of the secure intermediary device.

In some embodiment, a secure intermediary device automates or improves multi-part authentication by automated local communication between devices, such as with a local short distance radio or sound or infrared or cabled signals, to a second computing device used to provide secondary device data replies. In one example, short distance of these signals needed as a protective layer against nefarious remote parties attempting to emulate these local communications, and/or the paired secondary device is emulated on-board the secure intermediary device or on a device that communicates with the secure intermediary device.

In some embodiments, a secure intermediary device implements a secure log-in to prevent access by unauthorized entities using a localized peripheral device login. In one example, the login uses multi-factor methods of authentication using artificial intelligence (AI), customized local devices with voice, sound, visual, or mechanical movements of a human input, etc. In some embodiments, the secure intermediary device will time-out of login or trigger an alarm based on unauthorized removal from a specified geofenced area. In some embodiments, the secure intermediary device will time-out of login or trigger an alarm based on removal of the secure intermediary device from a specified area such as an aircraft, ship or vehicle.

In some embodiments, a secure intermediary device implements special symmetric or asymmetric-encrypted connectivity to include approved brick-and-mortar geographic locations that include custom hardware-software to update itself, its cartridges, its attachments, etc. This enables secure software-firmware updates to avoid less than fully secure pathways to prevent the entrance of malware into the secure intermediary device or associated devices. In some embodiments, the secure intermediary device includes one or more features for locking updating cartridges or components to an approved location such as an approved geographic location, or approved vehicle location where the updating happens. In some embodiments, updating the secure intermediary device is performed such that spoofed updates are detectable, such as by public key cryptography, and so that an origin of the update can be identified or verified.

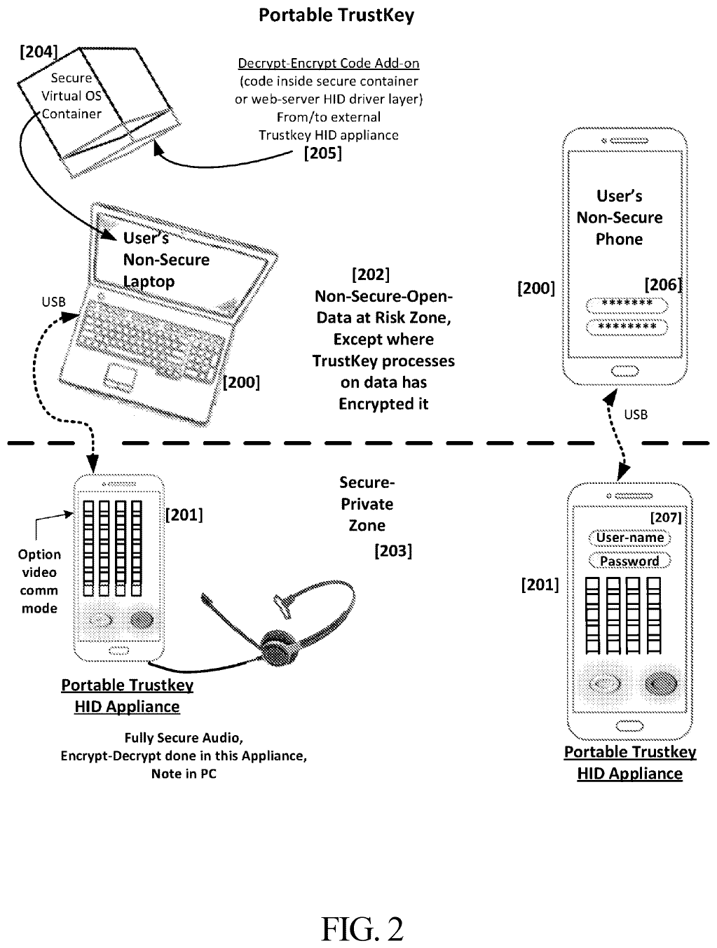

FIG. 2 illustrates trustkey functionality of a secure intermediary device in some embodiments. In various embodiments, secure intermediary device 201 communicates with a user input device such as a HID keyboard or HID pointer device to obtain user input with custom single task-oriented software.

In some embodiments, secure intermediary device 201 is based on a functionality-reduced multitasking computing device such as a smartphone. In some embodiments, secure intermediary device 201 includes an operating system that performs software-driver control of the hardware circuits of a secure display, user input, or audio output ports. In some embodiments, secure intermediary device 201 communicates with a non-secure device 200 such as non-secure laptop or smartphone, thereby creating portable full data security and privacy with symmetric and asymmetric encryption, I/O for audio-video communications, texting, and network transactions. In some embodiments, secure intermediary device 201 is unlocked using authentication information such as a username and password, fingerprint, etc. to prevent unauthorized use of secure intermediary device 201. In some embodiments, secure intermediary device 201 stores several local passwords for several independent users with their own and some shared passwords, macros, or other data associated with the users. In some embodiments, secure intermediary device 201 communicates with a digital wallet device, enable fully secure use of information in the digital wallet device, avoiding exposing non-encrypted user I/O data to multitasking computing device 200 or other computing devices.

In some embodiments, whereas the non-secure common multitasking smartphones, laptops, and personal computers may contain a virtual OS container 204 within or with specially modified applications such as browsers, email, databases, or word processors with added code 205, thus having the matching ability to unencrypt the HID data from an external HID, and also to encrypt data and send to the same external HID, and whereas both the nominally less secure browser and its associated server webpage can hand off the display of the users user-name and password to a display, whereas creating an overall secure zone 203 of Secure and Private user I/O data such as keyboard, audio-video, memory files and an overall non-secure zone 202 which can contain virtual OS container 204 inside the multi-tasking computing device 200. In some embodiments, virtual OS container 204 includes code 205 which can process secure data to/from the secure intermediary device 201, or even a much less secure zone of a common web-browser inside a non-secure device 200 such as a common laptop, smartphone or PC that has code added-on for communicating with secure intermediary device 201, but still offers a better situation than complete open-non-secure user HID data being “in-the-open” throughout entire non-secure multitasking operating systems and can be easily intercepted by key-logger codes, and whereas a user may select the non-secure or semi-secure browser on their multitasking device display and the remote server webpage code to not show sensitive information 206 on the multitasking device display, but rather show sensitive information 206 on a secure display of secure intermediary device 201. In various embodiments, information associated with applications executed using non-secure device 200, such as an email application, is displayed using a secure display of secure intermediary device 201, such that the user uses secure intermediary device 201 to write emails in encrypted text and have them appear in plain text 207 on the secure intermediary device 201.

In some embodiments, secure intermediary device 201 is based on a commercial off the shelf (“COTS”) or mostly COTS smartphone that is re-programmed or originally programmed to perform functionality of secure intermediary device 201. In some embodiments, secure intermediary device 201 communicates with another typically higher cost, general purpose multitasking smartphone for which a lack of security and privacy for critical user names, passwords, unique user identifiers, software applications, web-browsers, email, and databases is to be resolved.

In some embodiments, secure intermediary device 201 communicates via a primary secure user I/O function with modified Internet browsers or other applications implemented using other computing devices that typically have non-secure operating systems to achieve fully secure connectivity to other remote peer-to-peer users, remote centralized servers, or remote distributed servers.

In some embodiments, secure intermediary device 201 providing secure user communications to a computing device with non-secure operating systems (OS) is further enhanced by way of custom add-on software to popular applications in said non-secure systems with software used to interact with browsers, email, financial and trading applications, or other applications that can use software addons to establish a more secure external hardware input with HID keyboard, HID pointer, and peripheral audio device and peripheral video device data streams from the secure input device to applications creating a secure-encrypted pipeline through a non-secure operating system residing in multitasking computing devices.

In some embodiments, secure intermediary device 201 includes a portable cartridge for transport of passwords and nonvolatile file memory in an easy to carry form factor for periodic optional connections to data backup systems that can also be virtual drives existing in the attached solid state memory stick with associated visual lights, or local display, and/or audio notifications of disk activity and security levels currently functioning.

In some embodiments, secure intermediary device 201 implements symmetric or asymmetric encryption connectivity to include brick and mortar geographic located franchises or owned locations that include custom hardware-software to update the portable device or its own dedicated attachments for secure software-firmware updates to avoid less than full secure pathways preventing the entrance of malware and for the avoidance of any malicious hardware or software.

In some embodiments, secure intermediary device 201 automates and improves multi-level authentication by automated local communication between devices such as with local short distance radio, or by sound or infrared or cabled signals, to a second device notably used for secondary device data replies, with the short distance of these signals being used as a protective layer against nefarious remote parties attempting to emulate local communications, and/or the paired secondary device is emulated on-board secure intermediary device 201.

In some embodiments, secure intermediary device 201 includes a secure login to prevent access to same device by unauthorized entities.

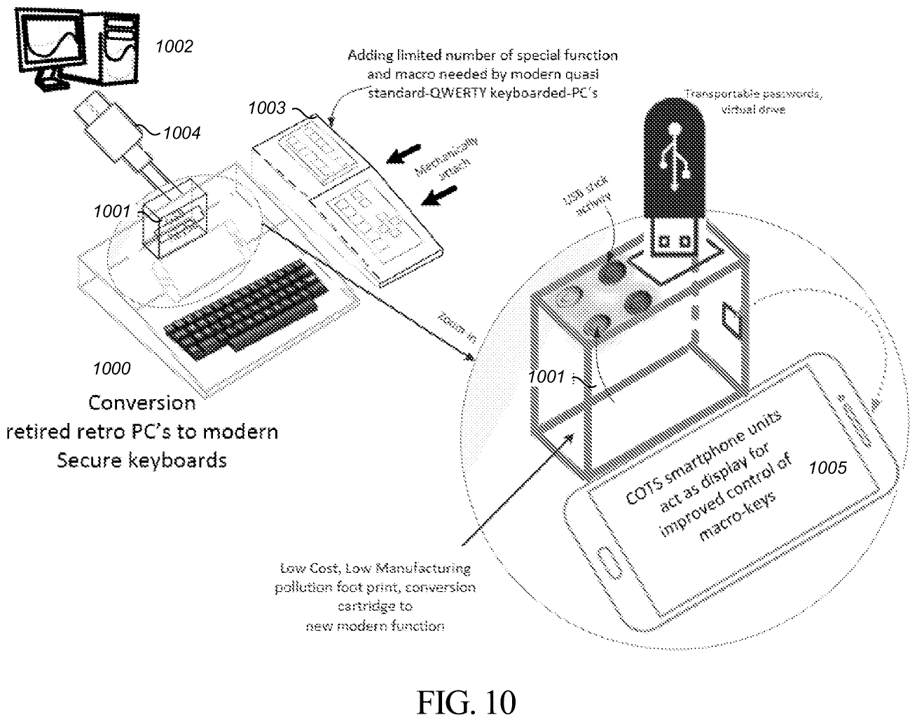

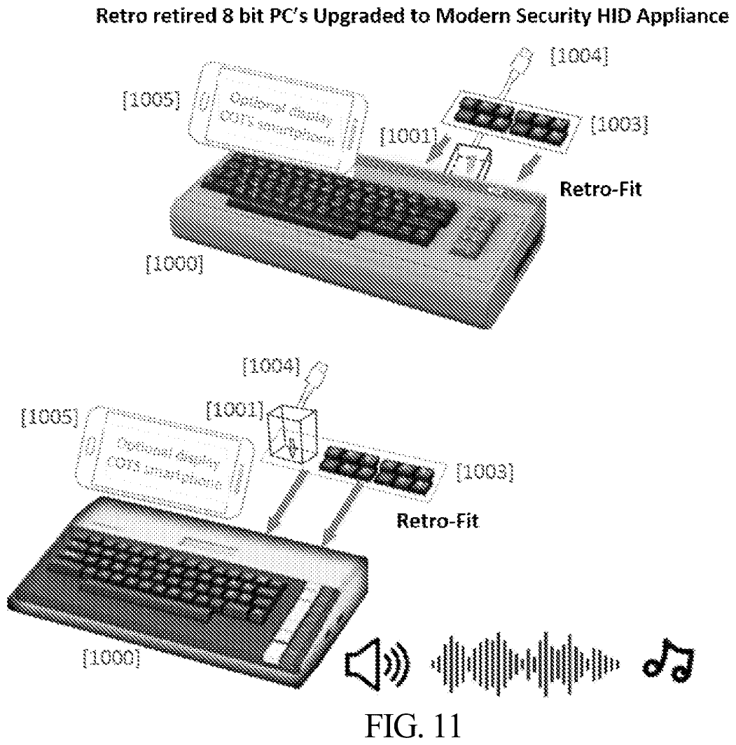

FIGS. 10 and 11 illustrate modular features of a secure intermediary device in some embodiments. In various embodiments, low cost, low pollution, and small manufacturing footprint, primarily single-function or limited-function cartridges for deterministically recycled and re-purposed retro computer systems into secure intermediary device 1000 that can be cartridge upgraded-with modern I/O connections to modern computers 1002 hosting multitasking operating systems with the same cartridge including additional keys 1003 to be mounted on the existing case of old or retired personal computer systems as to add the additional modern keys needed by popular operating systems, additional HID macro keys, and a communication channel 1004 connecting to modern personal computers enabled by the cartridge 1001 to act as a standard modern keyboard and/or pointing device and additional audio-visual indicators to inform the user of security levels in operation, and to optionally add the functions of a USB hub, smartphone charging, keyboard encryption, and local secure HID display 1005. In some embodiments, the modern secure intermediary device coding places the old retro PC video controller IC into sleep mode as to reduce power consumption and unwanted EMI, and leave as many memory cycles available for general purpose physical keyboard entry and other user HID function use. In some embodiments, encryption of user HID is performed in cartridge 1001 with a small, low power processor that also provides I/O for communication channel 1004 to connect to multitasking computing device 1002. In some embodiments, retro PC's simple joystick inputs could be brought back online as part of a modern HID for use with modern multitasking computing devices. In some embodiments, sensitive information such as user-names and passwords, are displayed using secure display 1005. In some embodiments, secure display 1005 is based on a multitasking computing device such as a smartphone. In some such embodiments, hardware, software, or both, of the multitasking computing device is modified to reduce a set of functions implemented using the multitasking computing device.

Referring to FIG. 8, in some embodiments, secure intermediary device 1000 includes two or more cartridge ports. In some embodiments, secure intermediary device 1000 includes digital or analog cross-connections between cartridges. In some embodiments, the cross connections enable several-but-separate single-tasking cartridges plugged-in to collectively provide new ways of mixing several applications, such as joining and mixing conferencing and voice phone calls from first phone cartridge 801 to second phone cartridge 802. In various embodiments, first phone cartridge implements a first communications application such as Signal, Zoom, Skype, Teams, other Voice over IP applications, etc., and second phone cartridge 802 implements a second communications application such as Signal, Zoom, Skype, Teams, other Voice over IP applications, etc. The modular functionality of secure intermediary device 1000 eases the use and improves the reliability and security of voice, sound, and video real-time communications while using multiple noncooperative communications applications whether those applications are from commercial-for-profit firms or from open-source-free providers. In contrast, the simultaneous multi-application functionality of current computers and smartphones enabled by multi-tasking non-secure operating systems so often wanted by consumers, have severe user security-privacy risks with little to zero knowledge of when cross communication of applications is occurring or is active, even when the user believes those applications are turned off.

Typically, retro computers include built-in RS-170 or PAL video outputs for display with the video using interleave memory access for its video raster, and shared memory cycles with general purpose computing as well as keyboard and I/O driver functions. In some embodiments, secure intermediary device 1000 converts the RS-170 or PAL video function off, so when connected, retro motherboard processor and memory cycles are not used to render video. This may also reduce unwanted radio-emissions. In some embodiments, the RS-170 or PAL display is enabled.

Often, retro computers include rather large, bulky, and demonstrably inefficient power supplies, most often of being +5VDC, but typically having arbitrary connection of the power-output ground rail attached to the 3rd prong safety ground of household 110 VAC or 220 VAC for input power. In some embodiments, secure intermediary device 1000 includes an efficient, low EMI, and floating ground output of the DC supply for improved safety, lower EMI, and optional user notification of power supply readout of voltage, current, and/or wattage, and able to accommodate sleep modes when user activity has stopped.

In some embodiments, secure intermediary device 1000 includes simple old style retro joysticks, or even retro basic LED barcode readers can become useful again for modern secure specialty HID functions. In some embodiments the functions are outside a peripheral device list default standard, such as the USB standard.

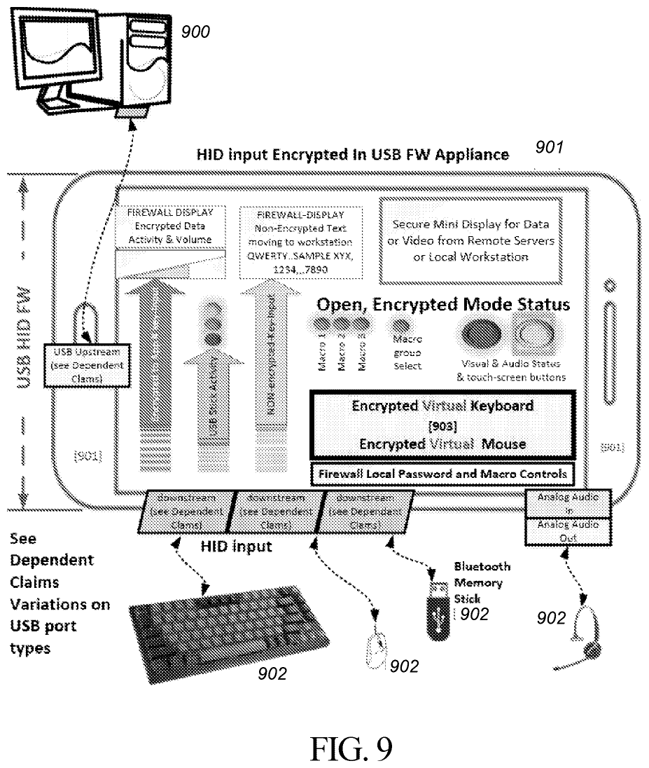

FIG. 9 illustrates input encryption using a secure intermediary device in some embodiments. In some embodiments, secure intermediary device 901 is interposed between multitasking computing device 900 that obtains user data from input devices 902, which may include HID keyboards or other user HID I/O devices. In some embodiments, secure intermediary device 901 is a re-purposed and re-programmed, low cost, typically COTS smartphone or other multitasking computing device with added USB ports side-A, the safe-side, which receives input from HID I/O devices, and side B, which communicates with multitasking computing device 900 or other multitasking computing devices. In some embodiments, secure intermediary device 901 implements a primarily single-tasking firewall software to avoid the risks of the existing multitasking systems. In some embodiments, display or audio outputs are used to indicate the passage of both safe encrypted and open (non-encrypted) data, such that a user is informed in real-time of the status of data movements to and from the system of main processor, memory, network connection and multitasking operating system and Internet access. In some embodiments, a processor and memory in the smartphone implements at least some functionality of virtualized HID devices 903 so the un-encrypted HID data can be re-processed into encrypted, and in reverse as well.

In some embodiments, secure intermediary device 901 acts to encrypt and decrypt input for open common user HID I/O devices. In some embodiments, secure intermediary device 901 includes buttons in virtual format or physical buttons, that act as macro keys for user-names and passwords as to better effectuate a user's secure authentication to various applications or platforms.

In some embodiments, secure intermediary device 901 is protected by a central password. In some embodiments, the central password is entered using any combination of input from one or more of input devices 902. In one example, the central password is based on selectable images known only to the user as to accomplish a highly secure password.

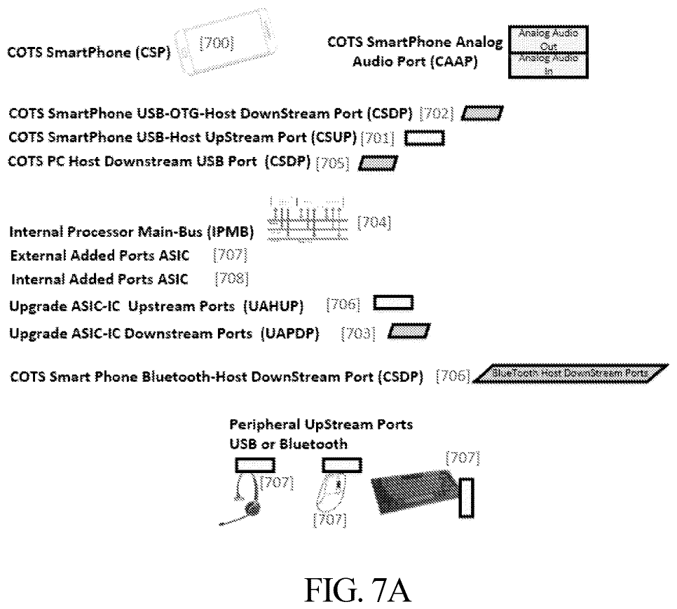

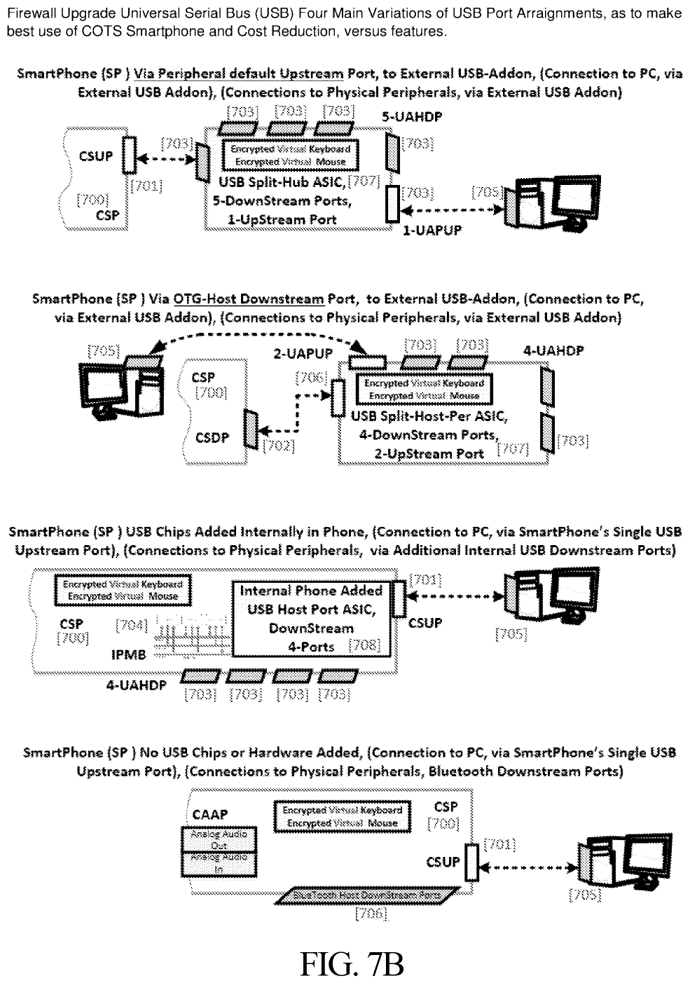

FIG. 7A illustrates aspects of converting a multitasking computing device 700 to implement a secure intermediary device in some embodiments. As discussed with respect to FIGS. 7A and 7B, multitasking computing device 700 is a smartphone.

In some embodiments, smartphone 700 is used to implement a secure intermediary device that communicates between a multitasking PC, laptop, tablet, or another smartphone through I/O port 705 and one or more user input devices such as a keyboard, pointer-mouse, memory-stick, headphones, video camera, etc. through I/O ports 701 or 702. In some embodiments, I/O port 701 or I/O port 702 operates simultaneously in the two modes of Host or Peripheral through upgraded I/O circuitry 703, which may include a Universal Serial Bus (USB) Large Scale Integrated (LSI) integrated ASIC circuit. In some embodiments, upgraded I/O circuitry 703 is included in smartphone 700, and communicates with a main bus 704 of smartphone 700. In some embodiments, upgraded I/O circuitry 703 is included in external ASIC 707, or an ASIC added internally to smartphone 700's processor-memory-control bus 708, along with upgraded firewall software and/or firmware, creating a secure intermediary device. In some embodiments, the secure intermediary device is factory assembled or upgradable in the field or at certified secure locations. In some embodiments, the secure intermediary device communicates with a server for testing of the validity of its firmware and IC functionality. In some embodiments, an existing Bluetooth downstream port 706 is used as a lower cost firewall appliance with no added hardware. However, this may limit external peripherals HIDs of keyboard and mouse to those that have Bluetooth connectivity. In some embodiments, a processor and memory of smartphone 700 implement a virtualized keyboard and a virtualized mouse.

In some embodiments, user's own external connecting HID peripherals of keyboard, pointer-mouse, memory-stick, headphones, camera and display. In some embodiments, smartphone 700 serves as a default secure communications display of the secure intermediary device and may also provide analog audio ports for HID microphone and headphones.

In some embodiments, raw non-secure user HID data streams including high value human keyboard entry such as passwords enter smartphone 700's downstream ports, to be processed by the virtualized internal phone user-HID's, data copies are modified via encryption as a core component of a the secure intermediary device's function, whether the COTS phone's USB ports set are upgraded or not, or the secure intermediary device is more dependent on the COTS phone's existing Bluetooth ports or other features.

In some embodiments, HID's data streams pass through the secure intermediary device's encryption process or not as per user selection, such that a Physical HID keyboard, human I/O data moves upstream toward the connection to a typical non-secure multitasking server, PC, laptop, tablet or another user controlled common smartphone for input/out to user HI D's with matching encryption-decryption done locally or remote via a network, whether done in software or done in another secure intermediary device.

In some embodiments, the secure intermediary device functions in lower USB modes matching common existing USB-org standard signaling, such as standard USB timing and protocol rules.

In some embodiments, the secure intermediary device provides a local endpoint to remote endpoint encryption and decryption requiring no additional drivers or software code for popular operating systems or locally connected popular USB peripherals.

In some embodiments, the secure intermediary device includes local password input to enable functions not only as human touch buttons-keys, touch-drag, but also using standard popular attached input devices such as inertial input devices.

In some embodiments, the secure intermediary device includes multiple levels of functionality that can be activated according to a user account associated with the secure intermediary device.

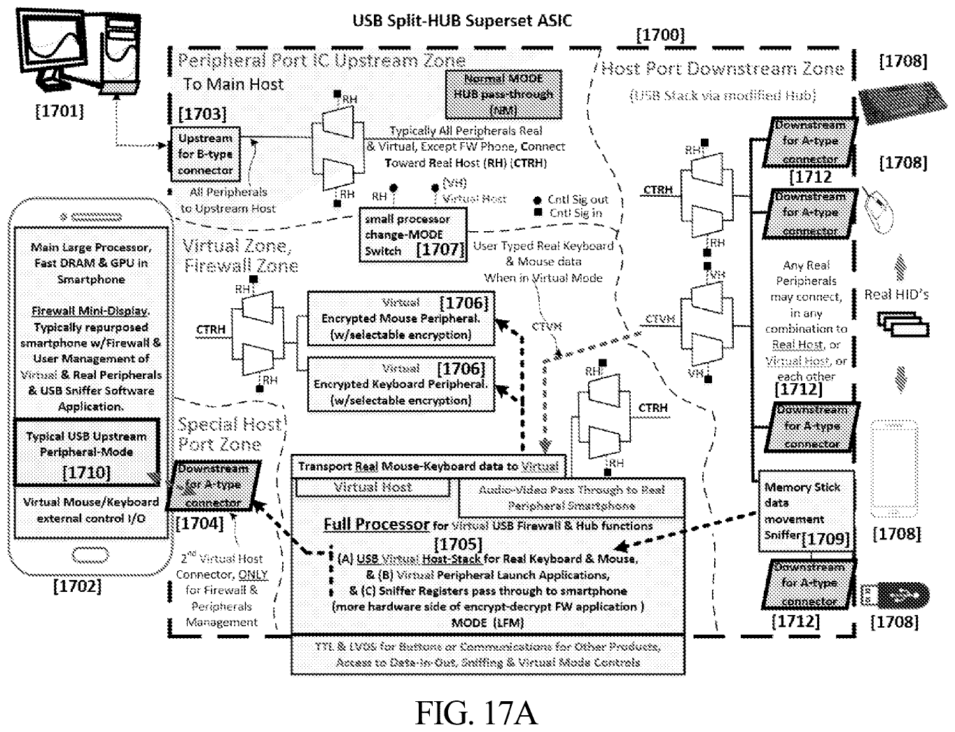

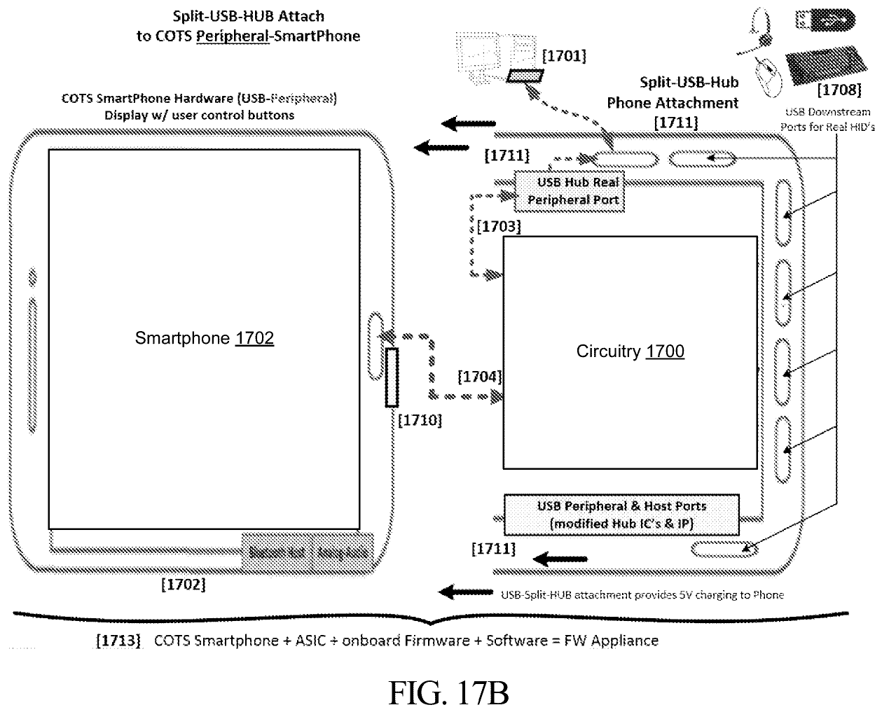

FIG. 17A illustrates a secure intermediary device having hub functionality in some embodiments. In some embodiments, the secure intermediary device connects to smartphone 700 externally via downstream I/O 1704 running in peripheral-upstream-mode, and serves as a modified and upgraded USB HUB function as part of the overall USB firewall function with on-board USB IC circuits group, embedded virtualized keyboard, and virtualized mouse. In some embodiments, upgrade as an external attachment for added firewall physical port counts and features as to make smartphone 700 a secure intermediary device for a typical multitasking PC or laptop 1701 and connecting to smartphone 700 externally via the phone's existing I/O 1704 running in typical default upstream-mode 1710, serves as additional five host downstream mode ports 1712, 1704 acting as part of the overall secure intermediary device with circuitry 1700, embedded virtualized keyboard 1706, and virtualized mouse 1706 as the real physical HID 1708. In some embodiments, the ASIC ports upgrade IC implements two I/O ports, a downstream I/O 1704 for communicating with smartphone 1702, and upstream I/O 1703 for communicating with multitasking computing device 1701. In some embodiments, a change mode switch can put the secure intermediary device into a simple hub mode.

In some embodiments, data received via upstream I/O 1703, downstream ports 1712, is processed using processor and memory of smartphone 1702. In some embodiments, functionality of the secure intermediary device is implemented using any combination of smartphone 1702 and circuitry 1700. In one example,, and optional Virtual HID encryption-decryption processing 1706 is performed using smartphone 1702. In some embodiments, processor 1705 is instantiated into circuitry 1700 for overall management of circuitry 1700 and data path directing, firewall functions, virtualizing, and user-peripheral memory sticks data movement sniffing module 1709. In some embodiments, circuitry 1700 is inside a case that attaches to smartphone 1702 in the field, repair shop, or firewall appliance factory, creating the secure intermediary device that includes smartphone 1702, circuitry 1700. In some embodiments, the secure intermediary device is implemented at least partially in firmware, software, or any combination thereof.

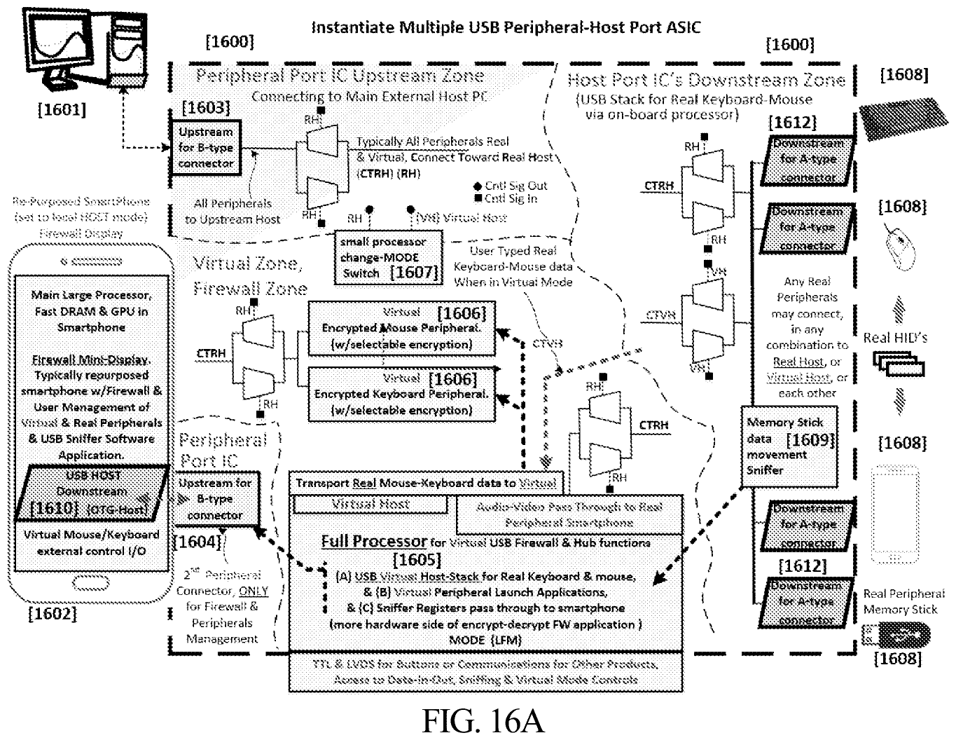

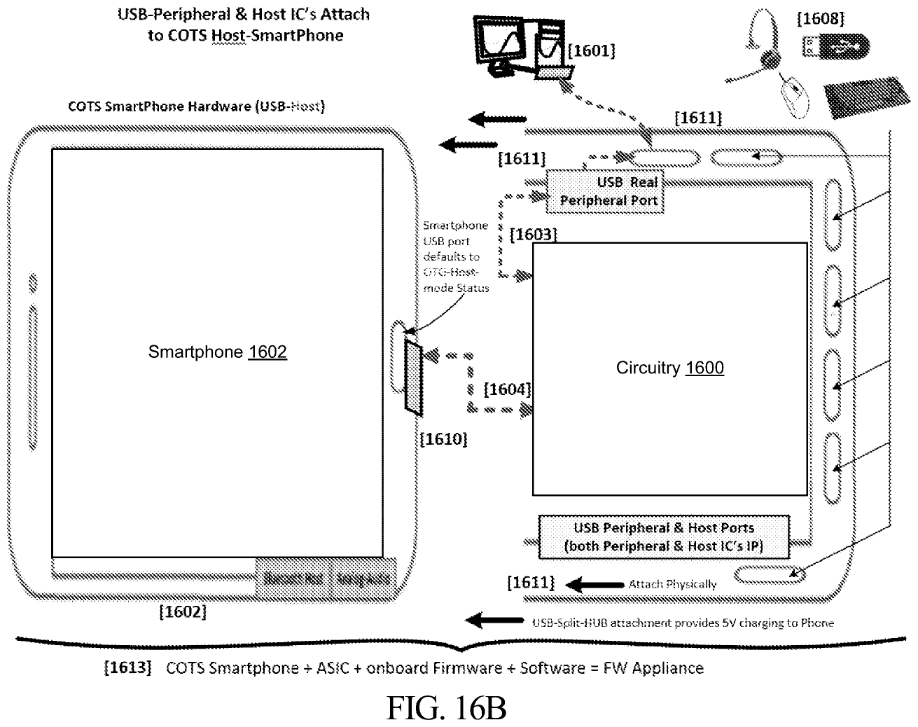

FIG. 16A illustrates input/output functionality of a secure intermediary device in some embodiments. In some embodiments, circuitry 1600 communicates with multitasking computing device 1601 and smartphone 700 externally via the phone's existing I/O 701 of smartphone 700 running in Host or OTG-Host-downstream-mode 1610, with additional multiple host-downstream mode ports 1612 acting as part of the overall secure intermediary device. In some embodiments, embedded virtualized keyboard 1606 and virtualized mouse 1606 are implemented using circuitry 1600 based on input received from physical user HID object 1608. In some embodiments, circuitry 1600 provides two upstream I/O, first upstream I/O 1604 for communicating with smartphone 1602 and second upstream I/O 1603 for communicating with multitasking computing device 1601. In some embodiments, a change mode switch can put the overall ASCI into a simple hub mode or enables first upstream I/O 1604, second upstream I/O 1603, downstream I/O 1612, or optional Virtual HID encryption-decryption processing module 1606.

In some embodiments, the virtual HID processing is performed using a processor and memory of smartphone 1602. In some embodiments, functionality the secure intermediary device is implemented using a combination of smartphone 1602 and circuitry 1600. In some embodiments, processor 1605 is instantiated in circuitry 1600 for overall management of circuitry 1600 and one or more of data path directing, firewall functions, virtualizing, and user-peripheral memory sticks data movement sniffer tasks 1609. In some embodiments circuitry 1600 is included in a case that removably connects to smartphone 1602 in the field, repair shop, or firewall appliance factory, such that smartphone 1602 and circuitry 1600 collectively implement the secure intermediary device.

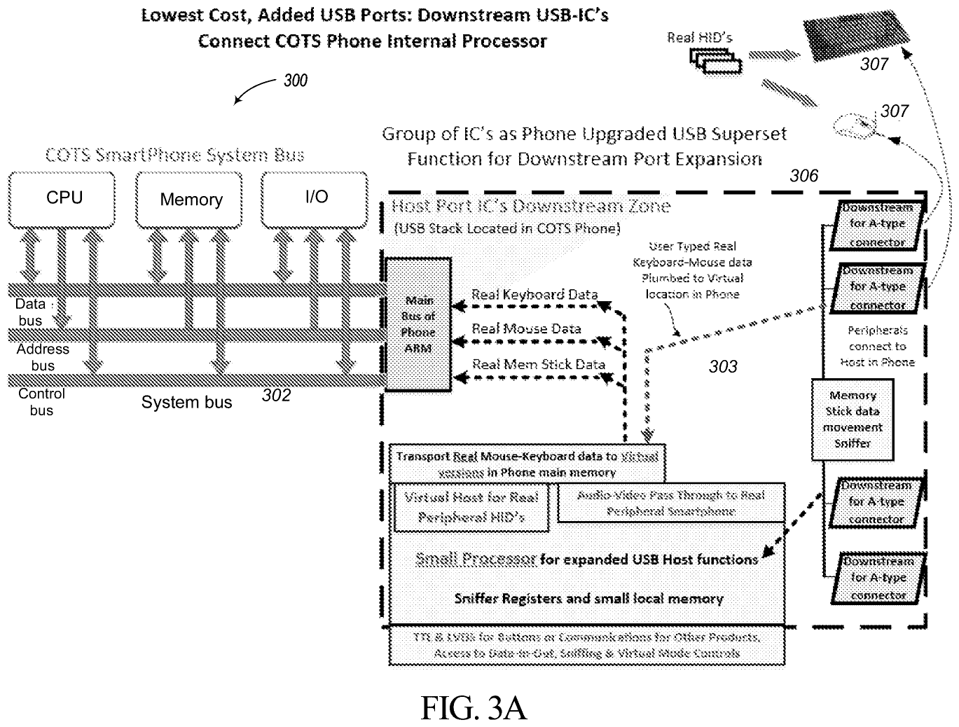

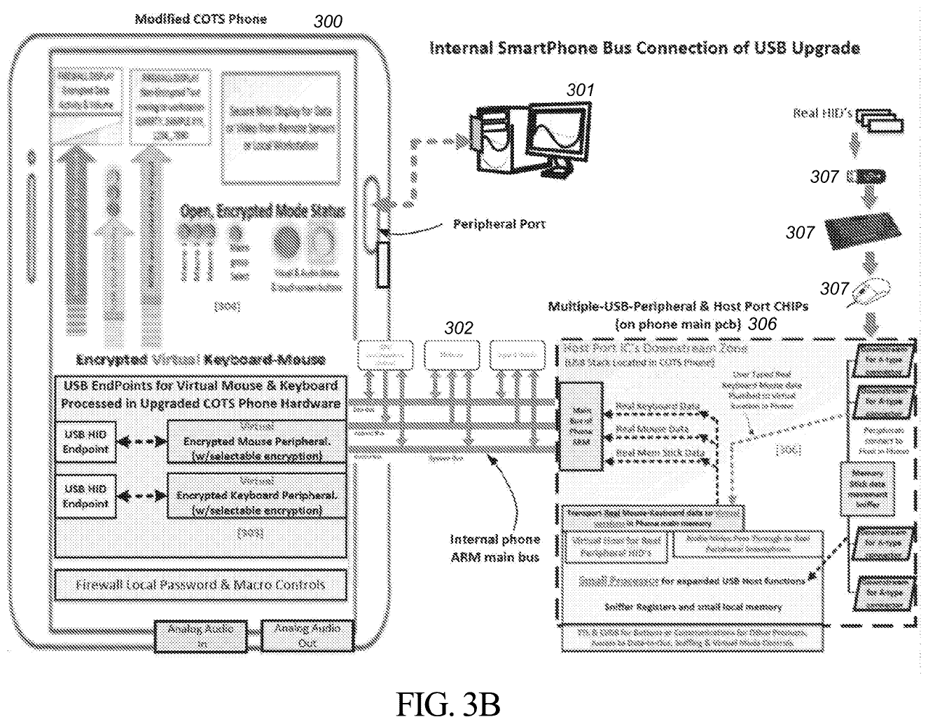

FIGS. 3A and 3B illustrate an internal smartphone bus connector for interfacing with a secure intermediary device in some embodiments.

In various embodiments, circuitry 306 is used in connection with a smartphone 300 to implement a secure intermediary device with user controls and display information for firewall control, data stream activity, or encryption safe and unsafe status.

In some embodiments, circuitry 306 enables added features by connecting to a system bus 302 of smartphone 300, either through I/O of smartphone 300 or through integration of connectivity to provide additional multiple host-downstream mode ports. In some embodiments a processor and memory of smartphone 300 implement virtualized input device 303, such as a virtualized keyboard or a virtualized mouse or virtualization of other input devices 307 such as a keyboard, pointer-mouse, memory-stick, headphones, or camera and display. In some embodiments, smartphone 300 communicates with multitasking computing device 301.

In some embodiments, smartphone 300 is used as a secure display for the secure intermediary device. In various embodiments, smartphone 300 implements, at least in part, various functionality of the secure intermediary device, such as an analog audio port for HID microphone and headphones.

In some embodiments downstream ports added using circuitry 306 pass through the virtualized HID peripherals processing for monitoring, encryption, and decryption of the users physical HID's data streams to a multitasking computing device. In some embodiments digital entities of specific software applications or virtualized operating systems interact using real-time symmetric or asymmetric encryption, with a multitasking computing device or secure intermediary device.

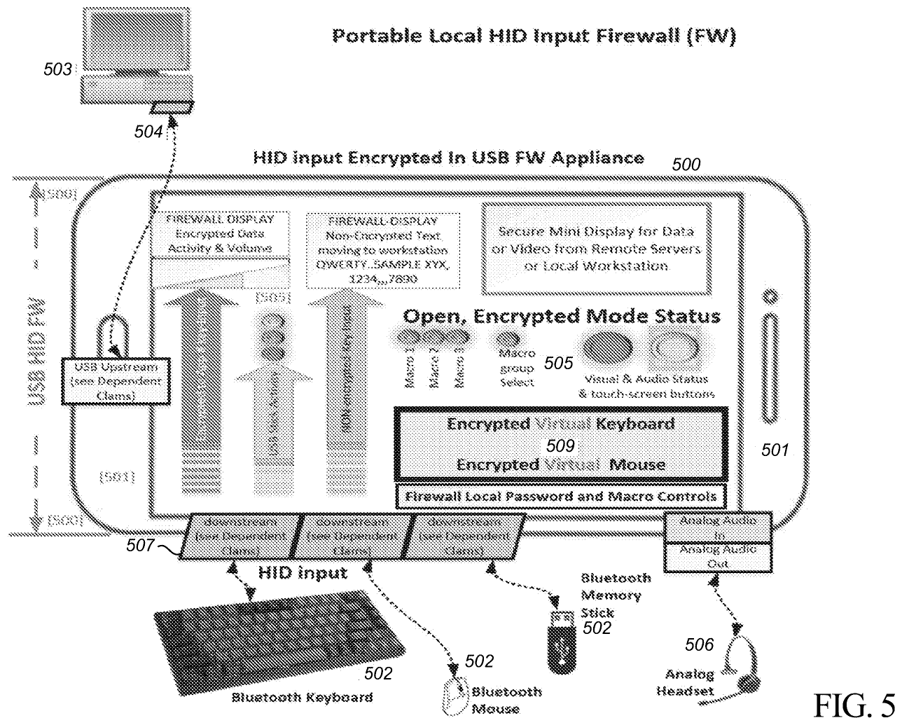

FIG. 5 illustrates a secure intermediary device implementing a portable local firewall in some embodiments. In some embodiments, functionality of secure intermediary device 500 is primarily firmware and software implemented using a smartphone 501 or other computing device, which avoids the costs of a new USB ASIC for connecting the user's HID Keyboard, pointer-mouse, memory-stick, headphone peripherals, etc. for adding features and connecting to smartphone 501 externally on smartphone 501's existing downstream I/O 507. In some embodiments, data of user's headphone 506 enters the secure intermediary device via the smart phone's analog-audio-port. In some embodiments, input devices 502 such as keyboard, pointer-mouse, memory-stick, camera, and display are received using downstream I/O 507. In some embodiments, a display 505 of smartphone 501 is used as a secure display of the secure intermediary device. In some embodiments, signals received using downstream I/O 507 pass through a virtualized HID peripherals processing module 509 for monitoring, encryption, and decryption. In some embodiments, signals associated with input devices 502 are used to create virtualized versions of the physical external HID devices, which communicate via upstream I/O 504, which provides a communication channel to the upstream multitasking computing device 503. In some embodiments, display 505 provides status indicators corresponding to one or more of input devices 502. In some embodiments, to create an end-to-end private-secure connection between an input device 502, internal display and headphones 506, and to either applications or a virtual machine OS inside multitasking computing device 503 or other device for memory, and control provides additional multiple downstream mode ports to act as part of secure intermediary device. In some embodiments, virtualized keyboard and virtualized mouse 509 is implemented using a processor and memory of smartphone 501.

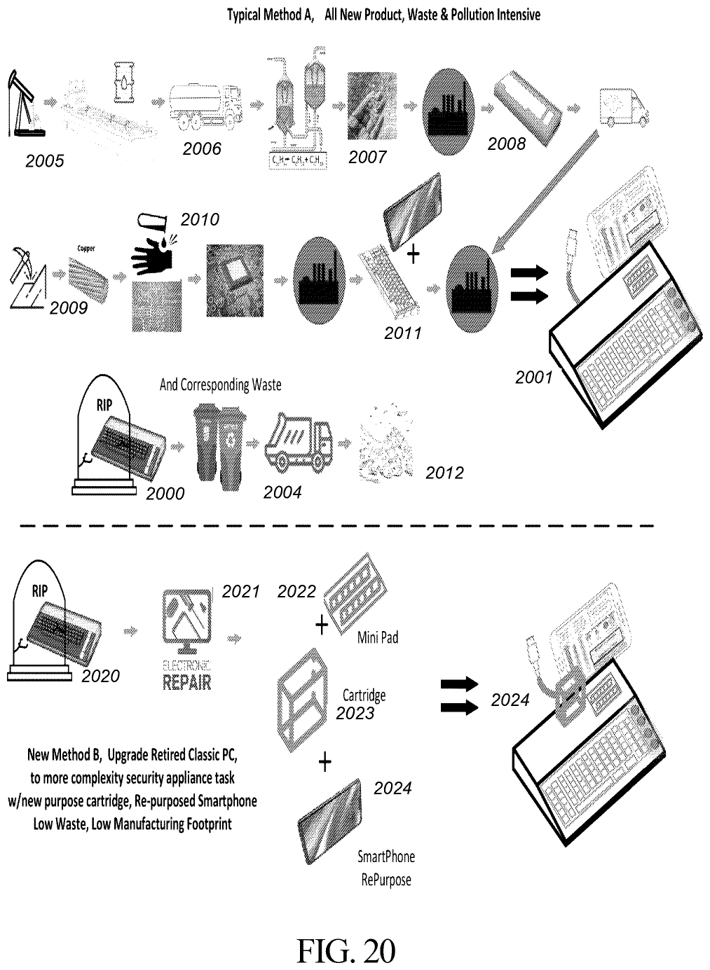

Embodiments of a platform based on a secure intermediary device are described below at least with respect to FIGS. 20-22.

Techniques disclosed herein enable a secure intermediary device-based platform or ecosystem. In various embodiments, the secure intermediary device, with or without its own keyboard, is a computing device that resides not just locally as firewall software in a personal computer workstation, or as a rack mounted unit that is a firewall for a single or multiple computer workstations against network or Internet security-privacy threats at a business, but also as an uncommonly segregated device with internal software that implements limited functionality for improved security. In some embodiments, the secure intermediary device intermediates between a user input devices and a multitasking computing device.

In some embodiments, the secure intermediary device provides access to a secure platform to an installed user base of smartphones, tablets, PCs, servers, or even retired low-cost retro computer systems.

In some embodiments, the secure intermediary device makes use of partner hardware, software, design language, etc. due to partners'exceptional brand and logo appeal. The partners may be computing device hardware manufacturers, software distributors, game developers, etc. In some embodiments, the secure intermediary device implements custom software to interact with an application of a partner through the secure platform. In one example, a cartridge of the secure intermediary device implements an application of a partner. In some embodiments, the intermediary device is styled according to a design language of a partner. In this way, affiliates that do or did have extraordinary levels of trust and high regard from their user base and a special historical marketing position can be utilized in a new secure platform. Various modern partners, such as distributed blockchain coinage has a similar but modern trust factor.

Where older computers, such as those produced by some partners, were limited in application tasks, this limited functionally delivered trust through having virtually no malware incursions. Additionally, suppliers of major components for a new fully secure privacy platform are suffering from overcapacity and over-supply of hardware devices and of Internet secure network services that can all be dovetailed into subscription service sales via partnerships that the business markets for sale or lease, or alternatively collects advertising fees from partner products providers by advertising on their behalf products that enhance the firms privacy and security products.

In various embodiments, the partners include classic 8 and 16 bit computer brand firms and/or associated user groups. Many such partners are struggling and but could be revitalized under a security-centric platform provided using secure intermediary devices.

In some embodiments, the secure intermediary device is compatible with open-source code associated with partner devices that often will be installed in some form, on its products, and for the early adopters that come much easier when penetrating a newly introduced and with incremental product improvements. In effect the combination of donations, friendship with modern user groups of open-source privacy and encryption coders and blockchain, and of the older, closed classic 8 and 16 bit computer user groups, and even retired programmers, engineers, marketers and sales persons of that era and classic computer genre, create a natural co-supportive network

The entrenched technology corporation's deeply capitalized finance and labor combined with their conglomerate business practices, effectively represents a form of legalized monopoly that often shuts out new small businesses with new product offerings. They form a high barrier to entry through the advantage of scaling to lower costs but also by denying prospective customers to learn of new offerings via control of search engines, on-line news, and e-commerce sites.

New platforms of hardware and software for secure and private networked communications, general purpose secure and private computing, secure and private networked financial transactions have largely been stifled by the few tech giants.

Customer types that large software and hardware OEM (original equipment manufacturer) firms often largely ignore are those that appear too small, too fragmented, and not aligned with high volume revenue models. Other smaller but substantial customer bases remain ignored often wanting product features that the conglomerates perceive as counter to their long term mission and goals. Large, publicly traded companies thrive not only on their high customer counts in the communications and data services areas, but also through having many brick-and-mortar stores that effectively pay prospective customers to visit with loss-leader product programs. Examples of the brick and mortar support for OEM's are the smartphone telecommunication stores that sell connectivity along with being VAR's (value added resellers) for the devices and their associated software.

The large companies tend to be saddled to the concept of constantly “new” and to double down on obsoleting older methods, services, and products. There are even court cases and legislatively passed laws attempting to force companies to allow for parts and repair manuals. There needs to be new ways to serve consumers who want to create their own customized solutions or to breathe new life into older systems they have a strong emotional commitment with.

There is an extraordinarily fast rising issue of ESG (environmental, social, and governance). Many large companies see recycling of physical products as more of a catchphrase or future promise. The concept is both unfunded, and largely unverifiable for a consumer when an original buy decision is made.

Even the newer methods of group funding via micro-investors that can include pre-purchasing of promised products too often leads to non-delivery or not working as well as expected.

Solvable issues restricting Internet centric technology markets worldwide:
MS-Windows™, Linux variants, Apple™ PC and phone, and Android™ all largely fail at fully secure privacy
Privacy oriented, tech service companies looking for a secure center point appliance
Large tech firms blocking new businesses via information knowledge and scaling ability
Millions of potential users as ignored customer groups (a good thing in this case)
Blockchain business restricted due to being largely funded by insider clubs of deep-pocket VC's
Thousands of small computer and digital game stores are underserved by the large tech companies
Lack of services and rejuvenation of classic computer systems and devices
Classic extraordinary well known tech brands of the 1980's fading away to almost nothing

The fundamental aspects for a new approach capitalizes on:
Unserved, overly complex, and semi-secure offerings of Digital Coin Owning-Trading
Unserved, overly complex, and semi-secure offerings for FinTech related commodities trading, oil, gas, precious metals, farm commodities, IP (ownership and licensing)
Modern multi-tasking smartphones, tablets, PC's, and servers are nearly impossible to make secure
High cost and equipment duplication for TV subscription viewing
High cost and equipment duplication for Audio-Video Compression
High cost and difficulty of use of PC-over-IP and Remote Desktop
Unserved user base of technology enthusiasts
Multiple methods are available via licensing and buyout to exploit the underutilized classic technology brands of the 1980's
Franchising with small computer stores and game stores, struggling to stay in business

In various embodiments, development of primarily single-tasking plug-in cartridges are core to the secure intermediary device. In some embodiments, the secure intermediary device includes a multi-feature secure keyboard. In various embodiments, the secure intermediary device brings robust security that is virtually impossible to hack and impervious to viruses or malware.

The advent of various cloud services that can incorporated is yet another high value service via subscriptions that can aid in users protecting their data, passwords, and trading.

The secure intermediary device can be integrated with current COTS components including smartphones with geo-location, Wi-Fi, Bluetooth, USB, audio-out, video-display, and touch screens to permit compelling feature sets to be added at very low cost. This is attractive for developers and retailers to cost-effectively fill out product lines.

There is a large base of programmers and developers who are excited at the chance to offer products such as cartridges for a single task secure appliance as contractors, or even side-hustles. In some embodiments, the secure intermediary device enables partners to add another layer of security to video communication feature expansion that many users need.

The customer base who own or follow retro 8 and 16 bit computers may be more technologically advanced as well as older with a historical record of being early-introduction-users. The worldwide aging population are more value-oriented as buying customers. The overlap with modern younger, technology-oriented users shows up in the interests of blockchain-based applications.

Multiple retro computers have intellectual property assets that can be licensed from current holders who struggle with bankruptcy. These retro computers sold millions of units, and many are still stored in closets and garages representing easy user acceptance. In some embodiments, the secure intermediary device includes visual design elements of retro computers or other partner devices.

In some embodiments, the secure intermediary device utilizes communication channels like YouTube™, Rumble™, or other independent freelance video makers can provide free product introductions and information.

In some embodiments, the secure intermediary device is based on a re-used system and is a viable alternative to expensive smartphones, tablets, or other computing devices with many families or small business already having multiple re-usable units sitting in drawers, closets, garages, etc.

FIG. 20 illustrates example manufacturing processes for the secure intermediary device in some embodiments. In various embodiments, rather than having devices just melted down or ground up to make simpler products like composite-wallboard or composite floor tiles which is a type of indirect-recycling, a newer, more complex approach to filling un-resolved communications and computing security issues that people face on a daily basis through well-defined directed recycling.

Typical manufacturing processes of purpose-built computer peripheral such as a keyboard involve pollution-intensive oil and gas drilling at step 2005, shipping of the same at step 2006, processing into plastics at step 2007, injection molding plastics factory operations at step 2008, additional waste, and more transport. In addition to these factors, there are the considerable electronic internals of copper metal mining at step 2009 and processing, circuit board and integrated circuit manufacturing involving extreme use of acids at step 2010 adding of new sub-components keypads and display at step 2011 all to achieve the finished new purpose built secure intermediary device 2001.

Retro devices produce waste at step 2000, either being harshly recycled into simpler materials at step 2004 or often sent to landfills at step 2012. A newer method of well-defined directed recycling moves materials from old retired devices directly into far more complex use cases. While many old systems were used primarily for entertainment-gaming, they can now be at the forefront of modern computer security and privacy for the reduction of digital identity and currency account theft. An older system 2000 is repaired if necessary via parts such as new keyboard membranes at step 2021. In one example, components of older system 2000 having atmospheric oxidation damage are replaced with parts that can be provided by small entities that are already producing these parts for classic retro computer user group communities. Adding new components of mini pads at step 2022, cartridges at step 2023, and repurposed smartphones at step 2024 enables a manufacturing footprint of roughly 10% of making a new finished purpose-built secure intermediary device, and makes for a component ready for use with longer life, overall better quality, as a secure intermediary device. Recycling components to produce the secure intermediary device is referred to herein as “deterministic recycling.”

Determinist recycling to newer, more complex, and more useful devices, such as the secure intermediary device, skips numerous steps typical in traditional recycling which includes increased levels of associated pollution, and should be welcomed by many people holding old retired systems, now with new processing and Internet connectivity as appliances with secure privacy functionally produced with low cost and pollution footprint.

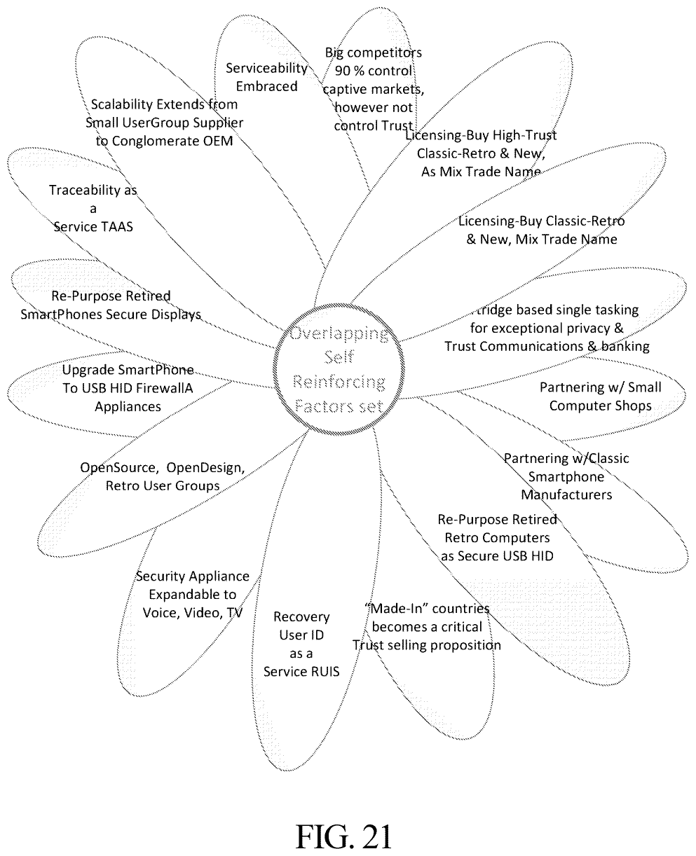

FIG. 21 illustrates various attributes of the secure intermediary device. Smart leveraging of partner resources enables the secure intermediary device to scale along multiple paths. Economically-minded research and development from open-source coding groups, product design and manufacture from contract firms, free marketing from user groups and forums, sales/service from computer stores upgrading retro-PC's to secure privacy appliances, mass production of complete purpose built secure privacy appliances, and COTS smartphone manufacturers, and telecom distributors all contribute to the secure intermediary device's success while keeping corporate costs low and reducing investment risks. This ramps up nicely with early adopter, budget friendly offerings while also property monetizing the legacy of multiple classic brands into one new combinational brand. In various embodiments, the secure intermediary device has a retro look-and-feel while supplying customers with the modern functionally they want and need.

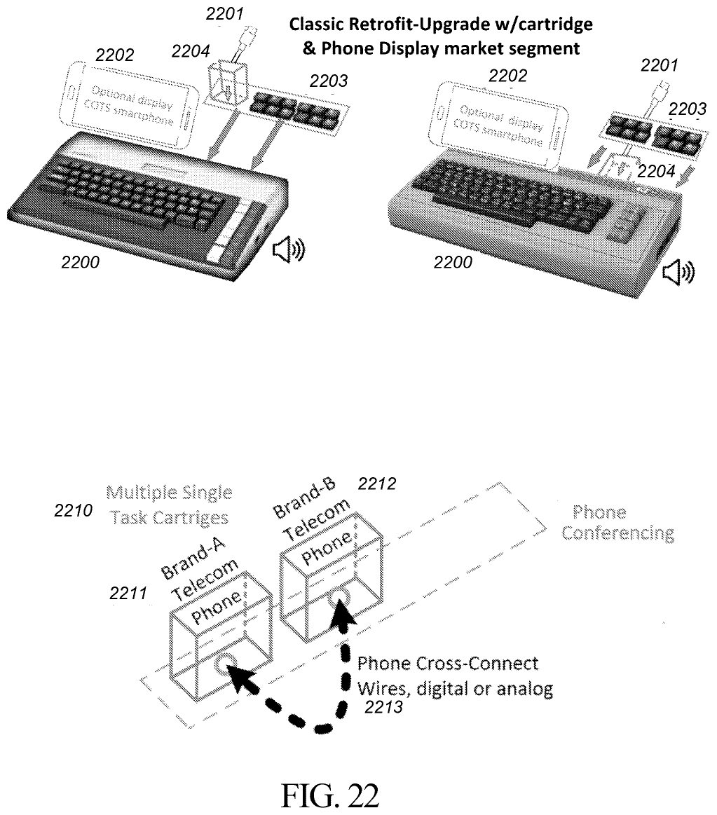

FIG. 22 illustrates features of a secure intermediary device implemented using a retrofitting kit in some embodiments. In some embodiments, the retrofitting kit converts retro-style devices for modern use as peripherals of the secure intermediary device along with upgraded versions as major components of modern private and secure systems for voice and video compression communications, or secure online transactions. In some embodiments, the secure intermediary device communicates with modern computers as a peripheral and to be as a substantially single-tasking device (e.g., as an input device, output device, etc.). In some embodiments, passwords and data encryption and decryptions are performed with secure intermediary device. In some embodiments, the secure intermediary device is located physically outside of a multitasking computing device with which it communicates. As discussed herein, multitasking computing devices often suffer from many security and privacy issues. Repurposing retro computers or components or peripherals thereof into a secure intermediary device for modern systems helps secure user inputs or other information provided via the multitasking computing device. In some embodiments, the retrofitting kit is usable to convert a retro system into a secure intermediary device that maintains a retro look and feel of the retro system.

In various embodiments, the retrofitting kit includes one or more of hub 2203, peripheral port 2201, cartridge 2204, or secure display device 2202, collectively “the secure intermediary device” with respect to FIG. 22. In some embodiments, hub 2203 includes one or more physical user input components such as one or more buttons, sliders, touchscreens, etc., or any combination thereof. In some embodiments, hub 2203 is configured to interface with cartridge 2204 via a wired or wireless connection.

In various embodiments, secure intermediary device functionality described herein is implemented using any combination of hub 2203, cartridge 2204, secure display 2202, or peripheral port 2201. In one example,

In various embodiments, hub 2203 includes I/O usable to interface with one or more of secure display 2202, cartridge 2204, peripheral 2200, a multitasking computing device, etc. In various embodiments, hub 2203 includes any number of I/O ports configured to interface with cartridges such as cartridge 2204. In one example, hub 2203 includes cartridges 2210, which include cartridge 2211 and 2212. As shown in FIG. 22, cartridges 2211 and 2212 communicate using connection 2213. In various embodiments, connection 2213 is configured to enable cartridges 2211 and 2212 to operate in series, in parallel, or any combination thereof.

In some embodiments, peripheral port 2201 is a communication channel by which the secure intermediary device communicates with a multitasking computing device. In various embodiments, the communication channel includes a wired connection such as a USB cable, a wireless connection such as a Bluetooth-based connection, or any combination thereof. In some embodiments, cartridge 2204 includes peripheral port 2201. In some embodiments, hub 2203 includes peripheral port 2201.

In various embodiments, peripheral 2200 is a user input device such as a keyboard, mouse, trackpad, touchscreen, joystick, controller, etc. In some embodiments, the retrofitting kit includes peripheral 2200. In some embodiments, the retrofitting kit does not include peripheral 2200.

In some embodiments, kits, software, and equipment product lines for retro retired computers to be upgraded into modern peripherals offered from a new OEM catering to vintage hobbyist groups that follow retro computers, whereas these old, now mostly disbanded user-groups, independent persons, and more modern general-purpose computer programming, and electronic hardware, user-group's independent persons, small computer brick-and-mortar stores, help to install kits and repair retro computers or components thereof such as peripheral 2200 that often have aged and oxidized keyboard contacts, thus providing free, honest, strong advertising and loyalty now given to the new kits provider that had been previously afforded to the businesses that manufactured the retro computers in the past with this method also being a win-win for both an ignored customer base and business OEM kit product suppliers, and to stress in marketing the re-use of older equipment that reduces pollution, both on the manufacturing side and the disposal side, and for possible recovery of commodities such as gold. In some embodiments, the retrofitting kit enables old retro cases to be retrofitted with new modern small PCB's with smaller, lower component counts.

Often owners of older retired peripherals may discover that contacts of the peripheral have oxidized, resulting in intermittent performance. In one example, peripherals may have missing keys. Small firms, typically hobbyist in nature, and for-profit suppliers, have already addressed a spare parts need, and whereas these small suppliers of repair parts for retro computers form a de-facto titular partnership and can assist for free at industry shows where the OEM kit supplier products are on display, and whereas the small firms parts suppliers, user-group independent persons, can showcase their own support for the OEM's principle products.

Often owners of older retired computers will find contacts of the computers have oxidized, thus intermittently connect, or may have missing keys. Small firms, typically hobbyist in nature, for-profit suppliers have already addressed a spare parts need, and whereas these small suppliers of repair parts for the older 8 and 16 bit computers form a Contractual partnership and can assist for free at industry shows where the OEM kit supplier products are on display, and its at least new OEM equivalency (non-kit) that even have a visual appearance and similar design to old classics. In some embodiments, computer shops, user-group independent persons, etc. showcase their ability for secure-private systems with code updates, as more secure updating of keyboard and cartridges may be desirable in a marketplace fraught with lack of trust for code updates especially on financial transaction systems. In some embodiments, the secure intermediary device created using the retrofitting kit provides protection against artificial intelligence systems that are used to inject spying or user-spoofing malware into the new secure-private user computer I/O products. In some embodiments, the secure intermediary device enables secured updates, such as at a designated update location.

Often owners of older 8 and 16 bit retired computer will find contacts of the computer have oxidized thus intermittently connect or may have missing keys, etc. In some embodiments, small firms, typically hobbyist by nature, and for-profit suppliers have already addressed a spare parts need. In some embodiments, these small suppliers of repair parts for the older 8 and 16 bit computers form a contractual partnership and can assist for free at industry shows where the OEM kits for secure intermediary devices are on display, and its wholly new OEM equivalency (non-kit) and that even have a visual appearance and similar design as old classics. In some embodiments, small firms such as computer shops, user-groups, or independent persons can showcase their ability for secure-private systems code updates as more secure updating of the secure intermediary device or cartridges. In some embodiments, the secure intermediary device prevents artificial intelligence systems from improperly inject spying malware. In some embodiments, the secure intermediary device enables authorized third-party updates or software distributions to be installed. This may reduce costs for consumers, improve performance of the secure intermediary device, and provide user choice.

In various embodiments, kits, software, or equipment product lines for retro computers to be upgraded into a secure intermediary device, and its wholly new OEM equivalency (non-kit) have a visual appearance and similar design to old computers offered from an OEM.

In some embodiments, audio warnings and cues to modes of operation of the secure intermediary device make use of licensed or purchased audio that are emotionally reminiscent of the 1980's retro computers or use newer sounds, and whereas this has appeal to users with a liking of gaming devices, and whereas user may copy in sound-data files of their choosing.

In some embodiments, audio warnings and cues to modes of operation of the secure intermediary device make use of licensed or purchased audio that are emotionally reminiscent of the 1980's retro computers or use newer sounds, and whereas this has appeal to users with a liking of business software, such as word processing and spreadsheets that had been used in gaming but are now used in business, as to enamor a likability of the overall new product line by business users.

In various embodiments, the secure intermediary device is based on an older or lower-performance product line (e.g., a product line of smartphones) not having the highest performance batteries or memory or processing capabilities. Especially in times where the business cycle may be in decline and end user consumers have smaller budgets but want to continue to upgrade their systems, or as more affordable favored presents.

In some embodiments, the secure intermediary device integrates with a partner VPN application, a partner anti-malware or antivirus application, or other partner applications, such as through a cartridge configured to execute the application or communicate with the application.

In some embodiments, the secure intermediary device integrates with a partner commodities trading firm that enables transactions in commodities and derivatives such as, oil, gas, gold, silver, blockchain digital currencies, stocks, bond and other financial instruments that can form a basket of investments or storing of values. In some embodiments, the secure intermediary device integrates with the commodities trading firm using an application programming interface of the commodities trading firm. In some embodiments, the commodities trading firm implements software that securely encrypts and decrypts communications with the secure intermediary device, improving security. In some embodiments, trading services are free or accessed via a subscription.

In some embodiments, the secure intermediary device includes a smartphone that provides a secure display and a desktop keyboards of both the retro repurposed PC's and the wholly new OEM equivalency (non-kit) that have a visual appearance and similar design to retro systems.

In some embodiments, to effectuate not just the actual improved security and privacy functions, and critically the self-security of the system, but also to show consumers how strongly the single-tasking methodology of improving security and privacy is both architected and is working like separated networks through cartridges plugged into the desktop appliance to add optional functions over the base unit, and to keep the base unit at a lower cost for easier first time purchases, and to be supportable.

In some embodiments, to supplant mainline large OEM suppliers HID user products by approval of other manufactures keyboards and other HID user devices, to further establish trust in the firm's systems, and that of all the various user HID devices of various types of keyboard, portable memory, audio and visual devices that are functionally tested together.

In some embodiments the a user-provided retro computing device or peripheral is upgraded into a secure intermediary device using a retrofit kit.

In some embodiments, one or more subscriptions are available for the secure intermediary device. In some embodiments, the one or more subscriptions enable secure updates, additional features, etc. In some embodiments, sales of services fosters follow-on appliance product upgrades, special function cartridges, attachments, or additional peripherals.

In some embodiments, the secure intermediary device is based on a non-functional retro style computer. In some embodiments, various circuits of the retro computer or other components such as a plastic case are incorporated into a new secure intermediary device to be compatible with modern computers and operating systems. Accordingly, the secure intermediary device may benefit from inherent trust and positive customer feelings toward the old retro computer brands. In some embodiments, the secure intermediary device includes a serialized tracking number or other identifier that indicates a limited edition or count status of the secure intermediary device.

In some embodiments where at least some functionality of the secure intermediary device is implemented using a multitasking computing device (such as a smartphone), the multitasking computing device is modified to operate in a single task-focused manner (rather than multi-tasking). In some embodiments, the multitasking computing device is physically modified, firmware or software of the multitasking device is modified, or any combination thereof.

In some embodiments, specific cartridge partners are rewarded for defined tallied and reported metadata of end user product-satisfaction reports about lack of security failures and ease of use.

In some embodiments, the secure intermediary device includes a specific function or service that backs up user data such as user-password or unique-user-identifiers such as needed to restore email accounts, communications accounts, whether commercial, government or open-source-software communications, buy-sell accounts, securities-commodities trading and banking, whereas the backup storage can be at a server associated with the secure intermediary device with optional off-network storage, requiring human intervention to store or read-back to user, and at designated trusted-friend's remote located computers, again with optional human-intervention required at optionally both the save-command-side, and at the remote storage side, with test-ability, as both a free and sold service. In some embodiments, the secure intermediary device offers other service-and-product providers methods to interface to this service, as to save their user-passwords and/or unique-user-identifiers, for their products in this firms methods. In some embodiments, user data stored using the secure intermediary device is protected using multi-factor authentication.

In some embodiments, the secure intermediary device includes multiple several single task cartridges 2210 plugged-in simultaneously allows for functionality of typically non-cooperative cross-applications to work together. In one example, first cartridge 2211 implements a first communication application and second cartridge 2212 implements a second communication application. Using first cartridge 2211 and second cartridge 2212, connected using connection 2213, voice phone calls from the first communication application and the second communication application can be merged. This markedly eases the use and improves the reliability of voice communications while using multiple noncooperative communications applications or other applications.

In some embodiments, the secure intermediary device includes a secure display 2202 that indicates a status of a firewall or encryption method in use by the secure intermediary device. In some embodiments, the secure display 2202 is used to provide notifications regarding security vulnerabilities of a smartphone or other multitasking computing device that are addressed by the secure computing device, such as through peripheral port 2201. In some embodiments, the notifications indicate non-trusted behaviors of present popular operating systems or equipment with which the secure intermediary device interacts.

In some embodiments, hub 2203 includes a speaker that provides audio indications of modes of operation. In one example, the speaker indicates when potentially malicious data is blocked by the secure intermediary device, when data is being transmitted to or from the secure intermediary device such as through peripheral port 2201, etc. In some embodiments, the audio indications make use of licensed or purchased audio that are emotionally reminiscent of the 1980's retro computers or use newer sounds, and whereas this has appeal to users with a liking of gaming devices.

In some embodiments, audio indications of modes of operation make use of licensed or purchased audio that are emotionally reminiscent of the 1980's retro computers and use newer sounds, and whereas this has appeal to users with a liking of business software, such as word processing and spreadsheets, that had been used in gaming, but are now used in business, as to enamor a likability of the overall new product line by business users.

In some embodiments, the secure intermediary device matches a physical appearance of a smartphone of other device used in connection with the secure intermediary device.

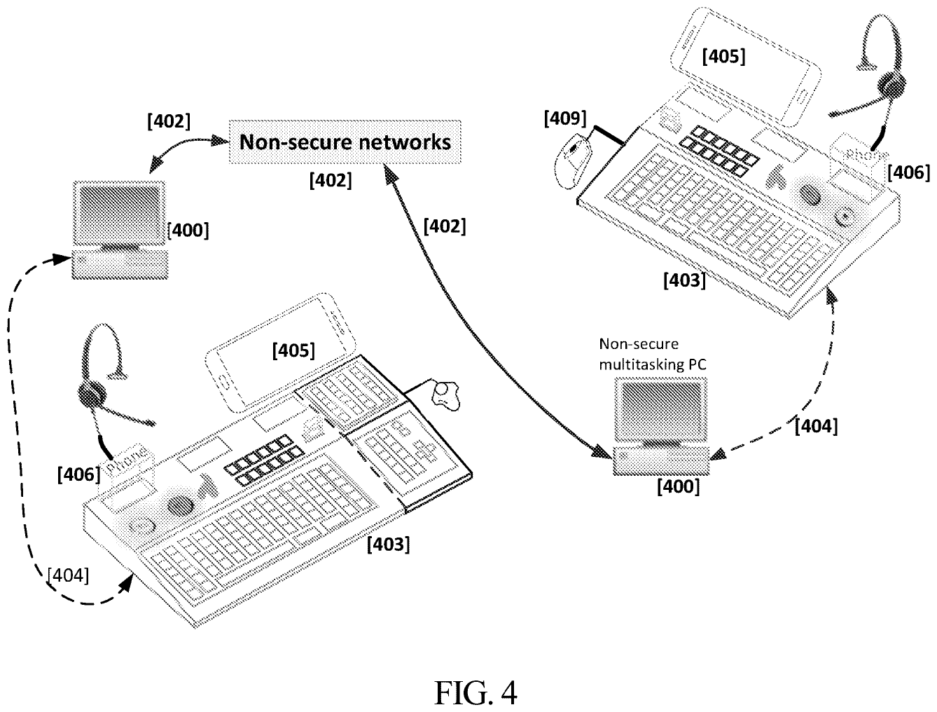

FIG. 4 illustrates peer-to-peer communication between secure intermediary devices in some embodiments. In FIG. 4, secure intermediary devices 403 communicate using end-to-end encryption via multitasking computing devices 400, over non-secure networks 402 and communication channels 404.

In some embodiments, the secure intermediary device 403 includes a keyboard or mouse-like user input device 409, wherein encryption and decryption of input data obtained using the input device takes place in the input device.

Accordingly, a multitasking computing device 400 in communication with the secure intermediary device may have no access, or very limited access to the user input I/O to application programs and/or to Virtual Operating Systems (OS's) both local and remote. In some embodiments, the secure intermediary device performs encryption and decryption from/to the security-privacy HID, or user peripheral I/O device to include audio and video. In some embodiments, the secure intermediary device includes a secure display 405, and one or more cartridges 406 with major functions of communications of audio or visual or both, for commodities or financial or digital-currencies stock-bond trading, or for other applications.

In some embodiments, the secure intermediary device 403 implements a firewall between a local computing device and a computing device intended to receive data from the local computing device, as an application or remote PC or server. In some embodiments, the secure intermediary device is aimed at a market of non-secure smartphone users and non-secure laptop and tablet users, thus ensuring greater levels of trust of the business partners for the benefit of the partners and their customers, and whereas a partnership with smartphone OEM makers is a manner to reduce costs of the portable appliance R&D and production, and-to gain penetration to the telecom carriers brick-and-mortar stores and their Internet stores that sell or lease smartphones along with well establish brands of common carrier Internet and phone service.

In some embodiments, the secure intermediary device interworks with an application of a partner such as a VPN service provider firm or am anti-malware or antivirus or firewall product firm to sell or lease subscription products that are implemented at least in part using the secure intermediary device.

In some embodiments, a partner cooperates with makers of popular software application programs for popular operating systems to produce new software add-ons from the business or the partners of popular software that allow private-secure digital communication with the secure intermediary device that has built in-encryption and decryption, as for more exclusive overall products and services competitive position.

In some embodiments, a partner firm trading in commodities and derivatives of same, to include (but not limited to) oil, gas, gold, silver, blockchain digital currencies, stocks, bond and other financial instruments that can form a basket of investments or storing of values implements software on their servers to match the secure intermediary device's encryption and decryption. In some embodiments, a subscription enabling the secure intermediary device to interwork with an application of the partner trading firm is offered.

In some embodiments, primary products and services, such as a secure intermediary device, marketed for sale or lease, or resold products and services of partner suppliers supplant mainline large OEM suppliers of smartphone and tablet devices, by establishment of trust in the firms systems and also to partner with the lesser smartphone OEM manufacturers whom have had past negative experiences with much larger parent firms as to aid in supplanting large conglomerates that maintain large market control via near monopoly status over whom shall and shall not achieve central status as a mainline platform for many software and hardware products for an easier partner pathway to those OEM smartphone suppliers, and the retro or near-retro brand recognition of those OEM suppliers.

In some embodiments, cartridge partners are rewarded for defined tallied and reported meta-data of end user product-satisfaction reports about lack of security failures and ease of use.

In some embodiments, the secure intermediary device incorporates an integrated circuit (IC) by way of licensing or purchasing the IC that implements a super-set of USB firewall-like functions that are typically not pursued by computer hardware OEMs. This enables secure operation even in a high-risk multitasking environment. In some embodiments, the IC and IC super-set function family may also function only in lower USB modes, all matching common existing USB-org standard signaling of physical connections (“phy”) and timing and protocol rules. In some embodiments, a string is used to control signaling of the IC.

In some embodiments, the IC or IC super-set function family provides a local endpoint to a remote endpoint encryption and decryption requiring no additional drivers or software code for popular OS's or local connecting popular USB peripherals thus being compatible across substantial numbers of existing and future operating systems the secure intermediary device may be connected to.

In some embodiments, the IC or IC super-set function family can have local password input to enable functions not only as human touch buttons-keys, touch-drag, but also using standard popular attachment input devices.

In some embodiments, the secure intermediary device implements the IC or IC super-set function family according to a permission scheme. In one example, first functions are available at a first subscription level and second functions are available at a second subscription level.

In some embodiments, the IC or IC super-set function family is developed with existing USB fabless IP chip firm partners, and partners are rewarded for defined tallied and reported metadata of end user product-satisfaction reports about lack of security failures and ease of use. In some embodiments, chip designs implementing the IC or IC super-set functions are altered for use with other devices.

In some embodiments, the secure intermediary device incorporates aspects of two, three, or more retro computing brands 8 and 16 bit computers. Whereas some of the 8 and 16 bit computer firms of the past were considered mortal competitive enemies of each other by the public, industry news sources, and wall street whom tracked the publicly traded firms. However the officers of the new firm, themselves as individuals having documented history to trace back to participation in multiples of these classic brands, formally bringing these struggling near-death brands under one joined multi-brand that marries the older iconic reusable equipment of those brands with new technologies, through purposeful multi-branding that links to the old brands, and whereas the multiple officers or ranking persons in the firm appear together in many venues and especially those venues of the classic computing brands technologies followers.

In some embodiments, technical persons from, and work with open-source coder individuals and teams for security and privacy oriented applications, and with joint attendance at events, and free advertising from this firm, for these donation funded volunteer coders, and direct donations, based on this firm's sales, both provides this firm's technical contacts to make its products and services as compatible as possible with the open-source code that often will be installed in some form, on its products, and for the early adopters for this firms products and services, whom are often either volunteer open-source coders or associated with same coders, or members of various associated user groups, whereas it is then easier to penetrate a newly introduced and with incremental product improvements.

The following is a summarization of the claims as originally filed.

A secure peripheral may be summarized as including: a retro computer peripheral, or portion thereof, configured to receive user input; a computing device that encrypts the user input received using the retro computer peripheral; a plurality of cartridge slots configured to interface with single-task-oriented cartridges; a secure display implemented using a feature-reduced smartphone; an expansion module slot configured to interface with an expansion module that includes one or more physical user input components; a transducer configured to indicate an operational status of the limited-functionality computing device; and a communication channel with a local multitasking computing device that enables the secure computer peripheral to provide the encrypted user input to a remote multitasking computing device via the local multitasking computing device.

In some embodiments, the feature-reduced smartphone is configured to implement at least some functionality of the computing device.

In some embodiments, the computing device is configured to implement a firewall between the secure computer peripheral and the local multitasking computing device.

An apparatus may be summarized as including: one or more processors; and one or more memories collectively configured to store contents executable by the one or more processors to cause the apparatus to: obtain user input data from a user input device; encrypt the user input data using the authentication information to produce encrypted user input data; and provide the encrypted user input data to a remote multitasking computing device using a secure application installed on the remote multitasking computing device.

In some embodiments, the apparatus includes one or more cartridge slots configured to interface with one or more single-task cartridges.

In some embodiments, the apparatus includes a single-task cartridge that interfaces with a cartridge slot of the one or more cartridge slots, the single-task cartridge including: a single-task-oriented computing device configured to securely perform a task that corresponds to the single-task cartridge.

In some embodiments, the task that corresponds to the single-task cartridge includes securely interfacing with a specified third-party application implemented using the remote multitasking computing device.

In some embodiments, the apparatus includes a secure display implemented using a feature-reduced smartphone.

In some embodiments, at least one of the one or more processors and at least one of the one or more memories are included in the feature-reduced smartphone.

In some embodiments, the one or more processors are configured to: obtain, from the remote multitasking computing device and via the computing device, encrypted data; decrypt the encrypted data to produce unencrypted data; and cause the secure display to display content based on the unencrypted data.

In some embodiments, the apparatus includes a retro input device that is retrofitted to include the one or more processors and the one or more memories.

In some embodiments, the one or more processors are configured to provide the encrypted user input data to the remote multitasking computing device through a local multitasking computing device.

In some embodiments, the one or more memories collectively store single-task-oriented software that exposes limited functionality to reduce security vulnerabilities of the apparatus.

A system may be summarized as including: a plurality of cartridge slots configured to interface with corresponding single-task-oriented cartridges; downstream I/O configured to obtain user input from a user input device; upstream I/O configured to communicate with a local multitasking computing device; and a function-limited computing device configured to: obtain user input data from the user input device via the downstream I/O; encrypt the user input data using the authentication information to produce encrypted user input data; and provide, using end-to-end encryption, the encrypted user input data to a remote multitasking computing device via the local multitasking computing device.

In some embodiments, at least two cartridge slots of the plurality of cartridge slots are configured to enable cartridges in communication with the at least two cartridge slots to operate in series or in parallel.

In some embodiments, providing the encrypted user input data to the remote computing device includes: providing the encrypted user input data to an internet browser extension application configured to decrypt the encrypted user input data.

In some embodiments, the system includes a single-task-oriented cartridge, wherein the one or more processors provide the encrypted user input data to a server that implements a service corresponding to the single-task-oriented cartridge.

In some embodiments, the system includes a retro keyboard that is the user input device, wherein the retro keyboard is retrofitted to include the plurality of cartridge slots, the downstream I/O, the upstream I/O, and the function-limited computing device.

In some embodiments, the system includes a secure display device that is a feature-limited smartphone configured to securely display content.

In some embodiments, the system includes a hub including a plurality of I/O ports.

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the automobile environment, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A secure peripheral comprising:
a retro computer peripheral, or portion thereof, configured to receive user input;
a computing device that encrypts the user input received using the retro computer peripheral;
a plurality of cartridge slots configured to interface with single-task-oriented cartridges;
a secure display implemented using a feature-reduced smartphone;
an expansion module slot configured to interface with an expansion module that includes one or more physical user input components;
a transducer configured to indicate an operational status of the computing device; and
a communication channel with a local multitasking computing device that enables the secure computer peripheral to provide the encrypted user input to a remote multitasking computing device via the local multitasking computing device.

2. The secure peripheral of claim 1, wherein the feature-reduced smartphone is configured to implement at least some functionality of the limited-functionality computing device.

3. The secure peripheral of claim 1, wherein the computing device is configured to implement a firewall between the secure computer peripheral and the local multitasking computing device.

4. An apparatus comprising:
one or more processors; and
one or more memories collectively configured to store contents executable by the one or more processors to cause the apparatus to:
obtain user input data from a user input device;
encrypt the user input data using the authentication information to produce encrypted user input data; and
provide the encrypted user input data to a remote multitasking computing device using a secure application installed on the remote multitasking computing device.

5. The apparatus of claim 4, comprising one or more cartridge slots configured to interface with one or more single-task cartridges.

6. The apparatus of claim 5, comprising a single-task cartridge that interfaces with a cartridge slot of the one or more cartridge slots, the single-task cartridge comprising:
a single-task-oriented computing device configured to securely perform a task that corresponds to the single-task cartridge.

7. The apparatus of claim 6, wherein the task that corresponds to the single-task cartridge includes securely interfacing with a specified third-party application implemented using the remote multitasking computing device.

8. The apparatus of claim 4, comprising a secure display implemented using a feature-reduced smartphone.

9. The apparatus of claim 8, wherein at least one of the one or more processors and at least one of the one or more memories are included in the feature-reduced smartphone.

10. The apparatus of claim 4, wherein the one or more processors are configured to:
obtain, from the remote multitasking computing device and via the computing device, encrypted data;
decrypt the encrypted data to produce unencrypted data; and
cause the secure display to display content based on the unencrypted data.

11. The apparatus of claim 1, comprising a retro input device that is retrofitted to include the one or more processors and the one or more memories.

12. The apparatus of claim 1, wherein the one or more processors are configured to provide the encrypted user input data to the remote multitasking computing device through a local multitasking computing device.

13. The apparatus of claim 1, wherein the one or more memories collectively store single-task-oriented software that exposes limited functionality to reduce security vulnerabilities of the apparatus.

14. A system, comprising:
a plurality of cartridge slots configured to interface with corresponding single-task-oriented cartridges;
downstream I/O configured to obtain user input from a user input device;
upstream I/O configured to communicate with a local multitasking computing device; and
a function-limited computing device configured to:
obtain user input data from the user input device via the downstream I/O;
encrypt the user input data using the authentication information to produce encrypted user input data; and
provide, using end-to-end encryption, the encrypted user input data to a remote multitasking computing device via the local multitasking computing device.

15. The system of claim 14, wherein at least two cartridge slots of the plurality of cartridge slots are configured to enable cartridges in communication with the at least two cartridge slots to operate in series or in parallel.

16. The system of claim 14, wherein providing the encrypted user input data to the remote multitasking computing device comprises:
providing the encrypted user input data to an internet browser extension application configured to decrypt the encrypted user input data.

17. The system of claim 14, comprising a single-task-oriented cartridge, wherein the one or more processors provide the encrypted user input data to a server that implements a service corresponding to the single-task-oriented cartridge.

18. The system of claim 14, comprising a retro keyboard that is the user input device, wherein the retro keyboard is retrofitted to include the plurality of cartridge slots, the downstream I/O, the upstream I/O, and the function-limited computing device.

19. The system of claim 14, comprising a secure display device that is a feature-limited smartphone configured to securely display content.

20. The system of claim 14, comprising a hub including a plurality of I/O ports.
